(19) United States
(12) Patent Application Publication
(10) Pub. No.: US 2007/0182958 A1
(43) Pub. Date: Aug. 9, 2007

(54) APPARATUS AND METHOD FOR WAFER SURFACE DEFECT INSPECTION

(76) Inventors: Yuji Manabe, Kamakura (JP); Takahiro Jingu, Takasaki (JP)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/668,499

(22) Filed: Jan. 30, 2007

(30) Foreign Application Priority Data
Feb. 8, 2006 (JP) 2006-031266
May 26, 2006 (JP) 2006-146567

(51) Int. Cl. G01N 21/88

(52) U.S. Cl. 356/237.2

(57) ABSTRACT

A beam emitted from a first light source is shed on the surface of a rotating wafer to form a beam spot. Scattered light arising from foreign matter and other defects on the surface of the wafer is detected in a plurality of directions and output in the form of a signal. Vertical movement of the wafer surface is detected by using white light or broadband light from a second light source. The position of the beam spot on the wafer surface is corrected in accordance with the information on the detected vertical movement for the purpose of minimizing a coordinate error that may arise from the vertical movement of the wafer surface. Further, the emission direction and emission position of light generated from the first light source are corrected to minimize a coordinate error that may arise from variations of the first light source. These corrections are made to enhance the accuracy of the coordinates of detected foreign matter and other defects. Moreover, the illumination beam spot diameter is corrected to prevent the detection sensitivity and foreign matter coordinate detection error from varying from one apparatus to another.

### BACKGROUND OF THE INVENTION

The present invention relates to a wafer surface defect inspection apparatus and method for inspecting the surface of a bare wafer without a semiconductor pattern, a filmed wafer without a semiconductor pattern, or a disk for foreign matter and other defects.

Conventionally known technologies for inspecting the surface of a bare wafer without a semiconductor pattern, a filmed wafer without a semiconductor pattern, and the like for foreign matter and other defects are disclosed, for instance, by U.S. Pat. No. 6,201,601 (Patent Document 1), Japanese Patent JP-A No. 153549/1999 (Patent Document 2), Japanese Patent JP-A No. 242012/1994 (Patent Document 3), Japanese Patent JP-A No. 255278/2001 (Patent Document 4), and U.S. Pat. No. 6,922,236 (Patent Document 5).

The technology described in Patent Document 1 uses a laser as a light source, causes an illumination optics to irradiate a wafer with a vertical beam and an inclined beam, collects rays of light scattered from the wafer by using a parabolic mirror, and detects the collected rays of light with a detector. The scattered light derived from the vertical beam and the scattered light derived from the inclined beam are distinguished from each other by irradiating the wafer with two beams of light having different wavelengths, by intentionally providing an offset between spots irradiated by the two beams, or by alternating between the vertical and inclined irradiation beams. A beam irradiation position error, which occurs due to a change in the specimen height, is corrected by detecting the regular reflection of the inclined irradiation beam and changing the direction of irradiation by moving the mirror in accordance with the detected regular reflection. A papilionaceous spatial filter is placed at a position conjugate to the parabolic mirror condenser in order to limit the detection of a particular azimuth.

The technology described in Patent Document 2 relates to a measurement target surface inspection method, which obliquely irradiates the surface of a measurement target with light emitted from a light source via an optics, receives scattered light reflected from the surface of the measurement target, inspects the surface of the measurement target for foreign matter by relatively displacing the measurement target and optics during scattered light reception, and records the coordinate position of foreign matter. When inspecting the surface of the measurement target for foreign matter, this method measures the height of the measurement target, and corrects the coordinate position of foreign matter by using a signal representing the height of the measurement target.

Patent Document 3 describes a foreign matter inspection apparatus that obliquely irradiates a wafer with laser light, receives scattered light, which arises upon irradiation, from a plurality of directions, performs simulation or the like on the resulting received light signals to determine scattered light intensity distribution, determines the correlation between the resulting data values and the signals, and detects fine particles on the surface of the wafer.

Patent Document 4 describes a surface inspection apparatus that includes an illumination optics and a detection optics. The illumination optics includes an incidence illumination system, which provides incidence illumination over the surface of an inspection target, and an oblique illumination system, which provides oblique illumination over the surface of the inspection target. The detection optics includes a plurality of medium-angle detection optics, which detect scattered light that arises from the surface of the inspection target and is directed toward a medium angle, and a plurality of low-angle detection optics, which detect scattered light that arises from the surface of the inspection target and is directed toward a low angle. The surface inspection apparatus distinguishes between shallow scratches and foreign matter by detecting intensity changes in the scattered light that arises from shallow scratches and foreign matter during incidence illumination and oblique illumination. Further, the surface inspection apparatus distinguishes between linear scratches and foreign matter by detecting the directivity of scattered light during incidence illumination.

Patent Document 5 describes a surface inspection apparatus that includes an illumination optics and a plurality of detection optics. The illumination optics includes an incidence illumination system, which provides incidence illumination over the surface of an inspection target, and an oblique illumination system, which provides oblique illumination over the surface of the inspection target. The plurality of detection optics include a Fourier transform spatial filter and are positioned in a plurality of directions and at a plurality of angles to detect scattered light that arises from the surface of an inspection target. The incidence illumination system and oblique illumination system both include a magnification converter for changing a spot diameter. The incidence illumination system includes an anamorphic optics that comprises two prisms and converts a spot to an ellipse.

### SUMMARY OF THE INVENTION

However, Patent Documents 1 to 5 do not adequately define a method for correcting the displacement and dimensions of a vertical irradiation beam spot and oblique irradiation beam spot on the surface of a wafer with high precision and accurately detecting, for instance, the position coordinates of extremely small foreign matter or other defects on the surface of the wafer without being affected by the film thickness variation and film quality of the wafer surface even when the wafer surface is warped, undulated, or otherwise deformed. Further, the patent documents do not adequately define a method for minimizing the detection sensitivity and detected position coordinate variations among apparatuses.

The present invention has been made to solve the above problems and provides a wafer surface defect inspection apparatus and method for determining, for instance, the position coordinates of extremely small foreign matter and other defects on the wafer surface with high precision, accurately collating vertical irradiation results with oblique irradiation results, and accurately identifying the types (categories) of foreign matter and other defects while minimizing the detection sensitivity and detected position coordinate variations among apparatuses.

According to one aspect of the present invention, there is provided a wafer surface defect inspection apparatus and method, the wafer surface defect inspection apparatus comprising: a stage for rotating a wafer; an irradiation optics for forming a vertical irradiation beam spot by irradiating the surface of a wafer, which is rotated by the stage, from a substantially vertical direction with a beam emitted from a first light source, changing the emitted beam, and forming an oblique irradiation beam spot by irradiating the surface of the wafer, which is rotated by the stage for scanning purposes, from an oblique direction that is inclined from vertical; a detection optics for collecting scattered light arising from foreign matter and other defects on the surface of the wafer, receiving the collected scattered light, and outputting a signal representing the received scattered light when the irradiation optics forms the beam spots on the surface of the wafer; a height detection optics for shedding white light or broadband light, which is received from a second light source, onto the vicinity of the oblique irradiation beam spot, which is formed on the surface of the wafer by the irradiation optics, causing a detector to receive the resulting reflected light, and detecting the surface height of the wafer in the vicinity of the oblique irradiation beam spot; and beam spot position correction means for correcting the position of the oblique irradiation beam spot, which is formed on the wafer surface by the irradiation optics, in accordance with the information on the wafer's surface height prevailing in the vicinity of the oblique irradiation beam spot, which is detected by the height detection optics.

According to another aspect of the present invention, there is provided the wafer surface defect inspection apparatus and method, wherein the detection optics includes a plurality of light reception optics for collecting scattered light arising from the foreign matter and other defects in each of a plurality of directions centered around the beam spots, receiving the collected scattered light, and outputting a signal representing the received scattered light.

According to another aspect of the present invention, there is provided the wafer surface defect inspection apparatus and method, wherein the beam spot position correction means includes an irradiation position correction optics that corrects the position of the oblique irradiation beam spot by deflecting the emitted beam, which is shed onto the surface of the wafer from the oblique direction.

According to another aspect of the present invention, there is provided the wafer surface defect inspection apparatus and method, wherein the beam spot position correction means is configured to calculate a surface displacement correction value of the wafer in accordance with the wafer surface height information detected by the height detection optics and correct the position coordinates of the oblique irradiation beam spot by using the calculated displacement correction value.

According to another aspect of the present invention, there is provided the wafer surface defect inspection apparatus and method, wherein the beam spot position correction means makes corrections by exercising feedforward control in accordance with the wafer surface height information prevailing one or more revolutions earlier that is detected by the height detection optics.

According to another aspect of the present invention, there is provided the wafer surface defect inspection apparatus and method, wherein the beam spot position correction means makes corrections by exercising feedback control in accordance with real-time wafer surface height information detected by the height detection optics.

According to another aspect of the present invention, there is provided the wafer surface defect inspection apparatus and method, the wafer surface defect inspection apparatus further comprising: beam spot detection means for detecting the positional displacement and dimensions of the vertical irradiation beam spot or oblique irradiation beam spot that is formed on the wafer surface by the irradiation optics; an emitted beam correction optics for correcting the emission direction and emission position of a beam emitted from the first light source, which is included in the irradiation optics; and beam detection means for monitoring a beam position immediately after the emitted beam correction optics; wherein the emitted beam correction optics corrects the emission direction (tilt) and emission position (shift) of a beam emitted from the first light source in accordance with at least the positional displacement information on the vertical irradiation beam spot or oblique irradiation beam spot detected by the beam spot detection means and at least the positional displacement information on a beam that is emitted from the first light source and detected by the beam detection means.

According to another aspect of the present invention, there is provided the wafer surface defect inspection apparatus and method, wherein the irradiation optics includes a beam diameter enlargement optics (zoom type beam expander) that emits the emitted beam after correcting the magnification of the emitted beam in accordance with at least the dimensional information on the vertical irradiation beam spot or oblique irradiation beam spot detected by the beam spot detection means.

According to another aspect of the present invention, there is provided the wafer surface defect inspection apparatus and method, wherein the beam spot detection means includes an observation optics for observing a beam spot image that is directly formed on the wafer surface or a surface equivalent to the wafer surface.

According to another aspect of the present invention, there is provided the wafer surface defect inspection apparatus and method, wherein the detection optics includes a low-angle light reception optics and a medium-angle light reception optics.

According to another aspect of the present invention, there is provided a wafer surface defect inspection apparatus and method, the wafer surface defect inspection apparatus comprising: a stage for rotating a wafer; an irradiation optics for forming an oblique irradiation beam spot by irradiating the surface of a wafer, which is rotated by the stage, from an oblique direction inclined from vertical with a beam emitted from a first light source; a detection optics for collecting scattered light arising from foreign matter and other defects on the surface of the wafer, receiving the collected scattered light, and outputting a signal representing the received scattered light when the irradiation optics forms the oblique irradiation beam spot on the surface of the wafer; a height detection optics for shedding white light or broadband light, which is irradiated from a second light source, onto the vicinity of the oblique irradiation beam spot, which is formed on the surface of the wafer by the irradiation optics, causing a detector to receive the resulting reflected light, and detecting the surface height of the wafer in the vicinity of the oblique irradiation beam spot; and beam spot position correction means for correcting the position of the oblique irradiation beam spot, which is formed on the wafer surface by the irradiation optics, in accordance with the information on the wafer's surface height prevailing in the vicinity of the oblique irradiation beam spot, which is detected by the height detection optics.

According to another aspect of the present invention, there is provided a wafer surface defect inspection apparatus and method, the wafer surface defect inspection apparatus comprising: a stage for rotating a wafer; an irradiation optics for forming a vertical irradiation beam spot by irradiating the surface of a wafer, which is rotated by the stage, from a substantially vertical direction with a beam emitted from a first light source, changing the emitted beam, and forming an oblique irradiation beam spot by irradiating the surface of the wafer, which is rotated by the stage for scanning purposes, from an oblique direction that is inclined from vertical; a detection optics for collecting scattered light arising from foreign matter and other defects on the surface of the wafer, receiving the collected scattered light, and outputting a signal representing the received scattered light when the irradiation optics forms the beam spots on the surface of the wafer; beam spot detection means for detecting the positional displacement and dimensions of the vertical irradiation beam spot or oblique irradiation beam spot that is formed on the wafer surface by the irradiation optics; an emitted beam correction optics for correcting the emission direction and emission position of a beam emitted from the first light source, which is included in the irradiation optics; and beam detection means for monitoring a beam position immediately after the emitted beam correction optics; wherein the emitted beam correction optics corrects the emission direction and emission position of a beam emitted from the first light source in accordance with at least the positional displacement information on the vertical irradiation beam spot or oblique irradiation beam spot detected by the beam spot detection means and at least the positional displacement information on a beam that is emitted from the first light source and detected by the beam detection means.

According to another aspect of the present invention, there is provided the wafer surface defect inspection apparatus and method, wherein the irradiation optics further includes a spot diameter correction optics for making corrections to enlarge or reduce the diameter of a beam spot formed on the wafer surface in at least one direction in accordance with at least the dimensional information on the vertical irradiation beam spot or oblique irradiation beam spot detected by the beam spot detection means.

According to another aspect of the present invention, there is provided the wafer surface defect inspection apparatus and method, wherein the spot diameter correction optics includes a beam diameter enlargement optics for adjusting a beam diameter magnification.

According to another aspect of the present invention, there is provided the wafer surface defect inspection apparatus and method, wherein the spot diameter correction optics includes a magnification adjustment/beam shaping optics for shaping a beam by adjusting the magnification.

According to still another aspect of the present invention, there is provided the wafer surface defect inspection apparatus and method, wherein the irradiation optics further includes a profile correction element for correcting the illumination distribution of a beam spot formed on the wafer surface.

These and other objects, features, and advantages of the present invention will be apparent from the following more particular description of preferred embodiments of the invention, as illustrated in the accompanying drawings.

### BRIEF DESCRIPTION OF THE DRAWINGS

FIG. 1 is a configuration diagram illustrating a wafer surface defect inspection apparatus according to a first embodiment of the present invention.

FIGS. 2A and 2B are a schematic top view and front view illustrating the configuration of a detection optics according to the present invention.

FIG. 3 is a schematic diagram illustrating the configuration of an embodiment of a signal processing section shown in FIG. 1.

FIG. 4 illustrates effects that are produced when a light source for emitting light having two or more different wavelengths is used as a second light source according to the present invention.

FIG. 5 illustrates how an oblique irradiation position is displaced by the vertical movement of a wafer surface according to the present invention.

FIG. 6 illustrates a first modified version of an irradiation position correction optics for an oblique irradiation beam spot according to the first embodiment of the present invention.

FIG. 7 illustrates a second modified version of the irradiation position correction optics for the oblique irradiation beam spot according to the first embodiment of the present invention.

FIG. 8 illustrates the relationship between spot positions prevailing during beam spot scanning according to the present invention.

FIG. 9 shows the shape of a beam spot that is formed on the wafer surface according to the present invention.

FIG. 10 illustrates a control signal that flows when the irradiation position correction optics according to the present invention exercises feedforward control over an actuator.

FIG. 11 illustrates a control signal that flows when the irradiation position correction optics according to the present invention exercises feedback control.

FIG. 12 is a configuration diagram illustrating the wafer surface defect inspection apparatus according to a second embodiment of the present invention.

FIG. 13 is a perspective view illustrating a specific embodiment of a beam correction optics that is shown in FIG. 12.

FIG. 14 illustrates another embodiment of an observation optics that is shown in FIG. 12.

FIG. 15 is a flowchart illustrating an operation that is performed by the second embodiment shown in FIG. 12.

FIG. 16 shows a beam spot monitor image observed by the observation optics shown in FIG. 12 and a GUI display screen that indicates a detected spot size and spot position displacement.

FIG. 17 shows an example of a GUI display screen that indicates detected foreign matter position and type in accordance with the present invention.

FIG. 18 is a configuration diagram illustrating the wafer surface defect inspection apparatus according to a third embodiment of the present invention.

FIGS. 19A and 19B illustrate in detail the first embodiment of a magnification adjustment/beam shaping optics that is shown in FIG. 18.

FIGS. 20A and 20B illustrate in detail the second embodiment of the magnification adjustment/beam shaping optics that is shown in FIG. 18.

FIGS. 21A to 21C illustrate in detail an embodiment of a profile correction element according to the present invention.

### DETAILED DESCRIPTION OF THE PREFERRED EMBODIMENTS

Embodiments of a wafer surface defect inspection apparatus and method according to the present invention will now be described with reference to the accompanying drawings.

### First Embodiment

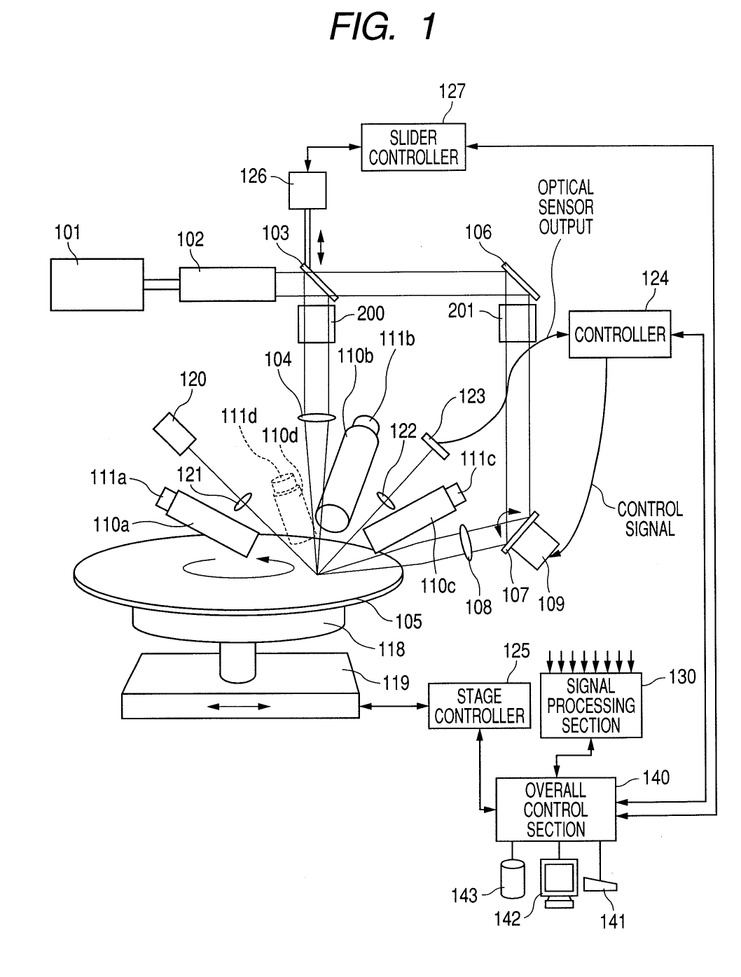

First of all, a first embodiment of the wafer surface defect inspection apparatus according to the present invention will be described with reference to FIGS. 1 to 9.

FIG. 1 is a diagram illustrating the wafer surface defect inspection apparatus according to the first embodiment of the present invention. It is preferred that, for example, a laser light source for emitting UV (ultraviolet) or DUV (deep ultraviolet) light to obtain high-intensity scattered light from extremely small foreign matter and other defects be used as a first light source 101 in order to detect extremely small foreign matter and other defects on a semiconductor wafer 105. More specifically, an argon laser, harmonic YAG laser, excimer laser, or the like should be used. The light emitted from the first light source 101 travels through a beam expander 102, bounces off a controllable mirror 103, which can be controlled by a uniaxial slider 126 such as an air cylinder or electric cylinder, passes through a beam shaping optics 200 and a vertical irradiation condenser lens 104, falls upon the semiconductor wafer 105 from a substantially vertical direction 80, and forms a vertical irradiation beam spot. The semiconductor wafer 105, which is a bare wafer without a semiconductor pattern, a filmed wafer without a semiconductor pattern, or the like, is set on a rotary stage 118. The rotary stage 118 is then placed on a uniaxial stage 119. The rotary stage 118 and uniaxial stage 119 are controlled by a stage controller 125 that operates in compliance with instructions from an overall control section 140. Similarly, the uniaxial slider 126 is controlled by a slider controller 127 that operates in compliance with instructions from the overall control section 140. During an inspection, the wafer 105 is rotated by the rotary stage 118 and fed in the direction of a radius by the uniaxial stage 119 so that a beam spot spirally scans the surface of the wafer 105.

When the controllable mirror 103 is retracted as indicated by an arrow, the light emitted from the beam expander 102 hits a mirror 106, another mirror 107, a beam shaping optics 201, and an oblique irradiation condenser lens 108, falls on the semiconductor wafer 105 from an oblique direction (within a range of 5 to 20 degrees from horizontal) 90, which is substantially equal to the direction in which the uniaxial stage 119 moves, and forms an oblique irradiation beam spot on the semiconductor wafer 105 and at the same position as the vertical irradiation beam spot. Mirror 107 is mounted on an actuator 109 so that the direction of reflected light can be changed to change the position of the oblique irradiation beam spot on the semiconductor wafer 105. The positions of the condenser lens 108 and mirror 107 may be interchanged.

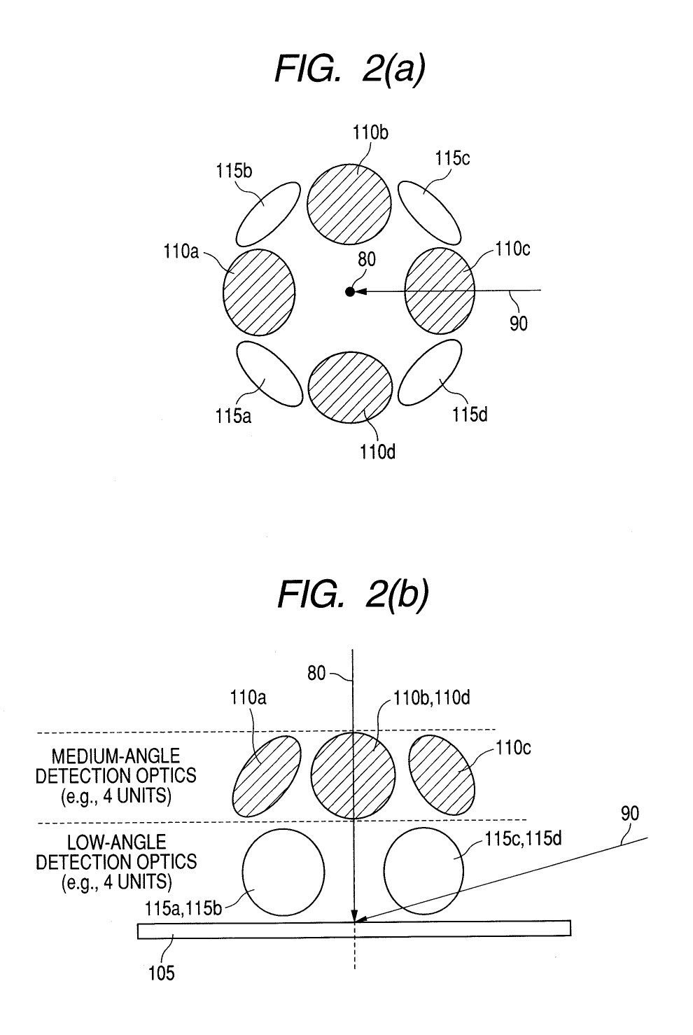

The emitted light is scattered when the vertical or oblique irradiation beam spot crosses any foreign matter or other defect on the semiconductor wafer 105. The scattered light is then received, detected, and converted to an electrical signal, for instance, by four medium-angle light reception optics 110a-110d and/or four low-angle light reception optics 115a-115d having photoelectric conversion sections (e.g., high-sensitivity photomultiplier tubes) 111a-111d. Although FIG. 1 shows a case where there are four medium-angle light reception optics 110a-110d, which are oriented toward the beam spot and inclined from the normal line of the semiconductor wafer, the present invention is not limited to such a case. For example, the employed configuration may alternatively include four low-angle light reception optics 115a-115d and four medium-angle light reception optics 110a-110d, which are centered around the beam spot as described in Japanese Patent JP-A No. 255278/2001 (Patent Document 4) or as shown in FIGS. 2A and 2B. As regards oblique irradiation, light reception optics 110a does not receive regular reflected light but receives and detects forward-scattered light from foreign matter and other defects, light reception optics 110b and 110d receive and detect side-scattered light, and light reception optics 110c receives and detects back-scattered light. As regards vertical irradiation, the light reception optics 110a-110d receive and detect scattered light rays that arise from foreign matter and other defects and are oriented in various directions. As regards oblique irradiation in a situation where medium-angle light reception optics 110a-110d within a range of 30 to 55 degrees from horizontal and low-angle light reception optics 115a-115d within a range of 5 to 30 degrees from horizontal are furnished, the medium-angle light reception optics 110a-110d receive scattered light from large particulate foreign matter so that a relatively great luminance signal is obtained, and receive scattered light from thin-film foreign matter, scratches, and other similar defects so that a relatively great luminance signal is obtained. On the other hand, the low-angle light reception optics 115a-115d receive forward-scattered light from large particulate foreign matter so that a relatively great luminance signal is obtained, and receive relatively small forward-scattered light or side-scattered light from thin-film foreign matter, scratches, and other similar defects.

As regards vertical irradiation, the medium-angle light reception optics 110a-110d receive scattered light, which is low-order diffracted light, from large particulate foreign matter so that a relatively great luminance signal is obtained, and receive scattered light, which low-order diffracted light, from thin-film foreign matter, scratches, and other similar defects so that a relatively great luminance signal is obtained. On the other hand, the low-angle light reception optics 115a-115d receive scattered light, which is relatively small high-order diffracted light, from large particulate foreign matter and from thin-film foreign matter, scratches, and other similar defects.

As described above, the use of a combination of vertical irradiation and oblique irradiation, which depends on whether the controllable mirror 103 is advanced or retracted, and a combination of the medium-angle light reception optics 110a-110d and low-angle light reception optics 115a-115d makes it possible to distinguish between particulate foreign matter and thin-film foreign matter, scratches, or various other foreign matter and defects.

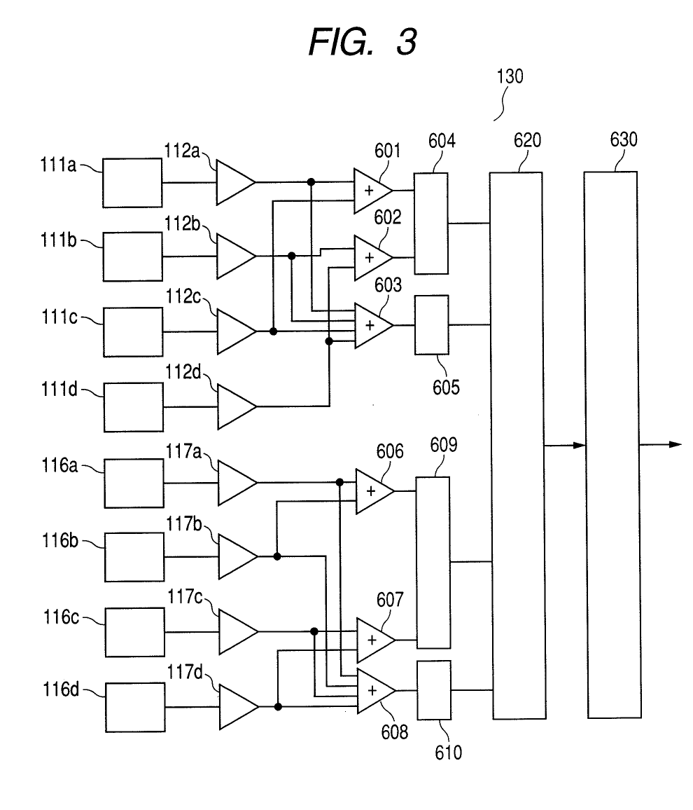

FIG. 3 shows an embodiment of a signal processing section 130. During vertical irradiation or oblique irradiation, the outputs from the photoelectric conversion sections (e.g., photomultipliers tubes) 111a-111d of the medium-angle light reception optics 110a-110d are processed by signal processing circuits 112a, 112b, 116c, 116d for amplification, noise elimination, and other purposes, and transferred out. The outputs from signal processing circuits 112a and 112c, which correspond to the scattered light that is scattered in the movement direction of the uniaxial stage 119, are added, for instance, by an addition circuit 601. The outputs from signal processing circuits 112b and 112d, which correspond to the scattered light that is scattered in a direction perpendicular to the movement direction of the uniaxial stage 119, are added, for instance, by another addition circuit 602. The addition output from addition circuit 601 and the addition output from addition circuit 602 are then fed to a comparison circuit 604 for magnitude comparison or ratio comparison. The result of such comparison is converted to a digital signal and stored in a memory 620. Consequently, a judgment processing section 630 can note the difference stored in the memory 620, detect the directivity of scattered light, and determine the types of foreign matter and other defects. In the case of vertical irradiation, the directivity of scattered light is not remarkable. In the case of oblique irradiation, however, the directivity of scattered light greatly differs between forward-scattered light and side-scattered light depending on the type of foreign matter or other defect. Therefore, the judgment processing section 630 can identify the types of foreign matter and other defects for judgment purposes by comparing the comparison result produced by the comparison circuit 604 and stored in the memory 620 at the time of vertical irradiation and the comparison result produced by the comparison circuit 604 and stored in the memory 620 at the time of oblique irradiation.

Further, during vertical irradiation and oblique irradiation, the outputs of all the signal processing circuits 112a-112d, which correspond to scattered light that is scattered, for instance, in four directions, are added by an addition circuit 603. A comparison circuit 605 performs conversion processing to generate a digital signal that represents the magnitude of the output of the addition circuit 603, and stores the generated digital signal in the memory 620. The judgment processing section 630 judges the sizes of foreign matter and other defects in accordance with the magnitude of the output (intensity) of the addition circuit 603, which is stored in the memory 620.

For size judgment purposes, the outputs of all the signal processing circuits 112a-112d need not be used at all times. If all such outputs are not used, foreign matter and other defects can be detected with a simpler circuit configuration. On the other hand, if the outputs of all the signal processing circuits 112a-112d are added and used, the output signal's signal-to-noise ratio can be improved. When, for instance, the outputs of the signal processing circuits 112a-112d are equal in signal strength s and noise strength n and three outputs are added together, the resulting signal strength is 3 s whereas the resulting noise strength is 3^{1/2} n. Therefore, the resulting signal-to-noise ratio is 3^{1/2} times higher than when one output is used. The reason is that the noises of the signal processing circuits 112a-112d do not correlate with each other because noise is generally shot noise.

Further, during vertical irradiation and oblique irradiation, the outputs from the photoelectric conversion sections (e.g., photomultipliers tubes) of the low-angle light reception optics 115a-115d are processed by the signal processing circuits 117a, 117b, 117c, 117d for amplification and noise elimination purposes and transferred out. The outputs from signal processing circuits 117a and 117b, which correspond to the scattered light that is oriented approximately 45 degrees from the movement direction of the uniaxial stage 119, are added, for instance, by an addition circuit 606, and the outputs from signal processing circuits 117c and 117d, which correspond to the scattered light that is oriented approximately 45 degrees from the movement direction of the uniaxial stage 119, are added, for instance, by an addition circuit 607. The addition output from addition circuit 606 and the addition output from addition circuit 607 are then fed to a comparison circuit 609 for magnitude comparison or ratio comparison. The result of such comparison is converted to a digital signal and stored in the memory 620. Consequently, the judgment processing section 630 can note the difference stored in the memory 620, detect the directivity of scattered light, and determine the types of foreign matter and other defects (distinguish between directional defects such as scratches and nondirectional defects such as foreign matter). In the case of vertical irradiation, the directivity of scattered light is not remarkable. In the case of oblique irradiation, however, the directivity of scattered light greatly differs between forward-scattered light and back-scattered light depending on the type of foreign matter or other defect. Therefore, the judgment processing section 630 can identify the types of foreign matter and other defects for judgment purposes by comparing the comparison result produced by the comparison circuit 609 and stored in the memory 620 at the time of vertical irradiation and the comparison result produced by the comparison circuit 609 and stored in the memory 620 at the time of oblique irradiation.

Further, during vertical irradiation and oblique irradiation, the outputs of all the signal processing circuits 117a-117d, which correspond to scattered light that is scattered, for instance, in four directions, are added by an addition circuit 608. A comparison circuit 610 performs conversion processing to generate a digital signal that represents the magnitude of the output (intensity) of the addition circuit 608, and stores the generated digital signal in the memory 620. The judgment processing section 630 judges the sizes of foreign matter and other defects in accordance with the magnitude of the output of the addition circuit 608, which is stored in the memory 620.

For size judgment purposes, the outputs of all the signal processing circuits 117a-117d need not be used at all times. If all such outputs are not used, foreign matter and other defects can be detected with a simpler circuit configuration. On the other hand, if the outputs of all the signal processing circuits 117a-117d are added and used, the output signal's signal-to-noise ratio can be improved. When, for instance, the outputs of the signal processing circuits 117a-117d are equal in signal strength s and noise strength n and three outputs are added together, the resulting signal strength is 3 s whereas the resulting noise strength is 3^{1/2} n. Therefore, the resulting signal-to-noise ratio is 3^{1/2} times higher than when one output is used. The reason is that the noises of the signal processing circuits 117a-117d do not correlate with each other because noise is generally shot noise.

As described above, the outputs from the signal processing circuits 112a-112d, 117a-117d, which are used to detect foreign matter and other defects in the signal processing section 130, may be determined as appropriate. They are not limited by the present embodiment. The number, arrangement direction, and arrangement elevation angle of light reception optics may also be determined as appropriate and are not limited by the present embodiment.

An embodiment for correcting the oblique irradiation beam spot on the wafer surface in accordance with the information on a wafer surface vertical movement position (wafer surface height) according to the present invention will now be described. Since the present invention selectively generates a vertical irradiation beam spot or oblique irradiation beam spot, it is necessary that the vertical irradiation beam spot and oblique irradiation beam spot represent the same position coordinates.

Under the above circumstances, it is first necessary to detect the wafer surface vertical movement position (wafer surface height) near a beam spot position. Meanwhile, it is probable that a bare wafer without a semiconductor pattern, a filmed wafer without a semiconductor pattern, or the like may be used as the semiconductor wafer 105. If a laser light source having a single wavelength is used as the illumination light source for detecting the waver surface vertical movement position in a situation where an attempt is made to inspect a filmed semiconductor wafer 105 whose surface is covered, for instance, with oxide film, regular reflected light may not be received because virtually no reflected light is obtained due to interference depending on the film thickness. This phenomenon occurs due to the dependence of surface film reflectance on wavelength when the laser wavelength of the light source coincides with the wavelength of the film having a low reflectance. In the above situation, therefore, the wafer surface vertical movement position (wafer surface height) cannot be detected.

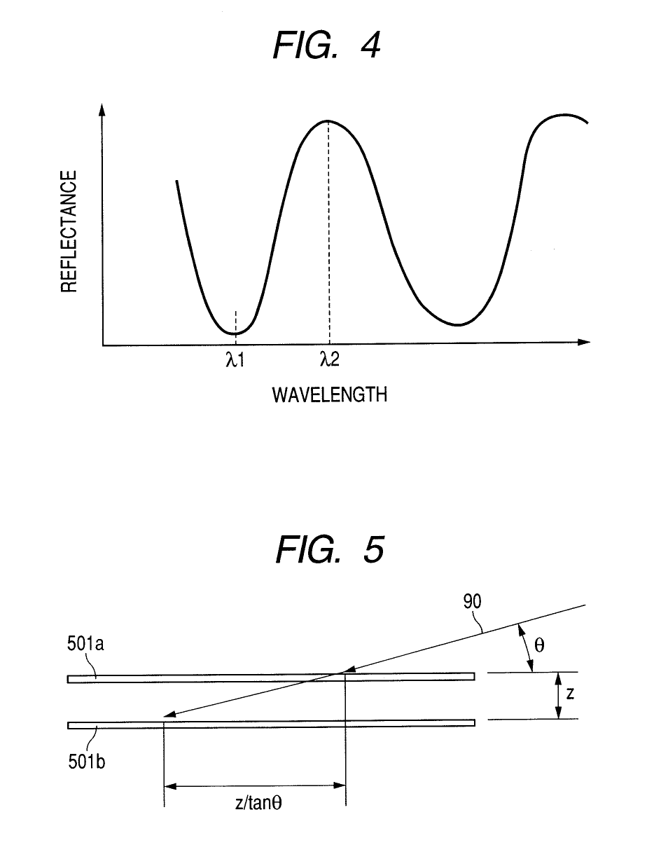

As such being the case, a light source that emits broadband light or white light is used as a second light source 120 that detects the wafer surface vertical movement position (wafer surface height) near a beam spot position. Effects produced when a light source for emitting light having two or more different wavelengths is used as the second light source will now be described with reference to a graph shown in FIG. 4. FIG. 4 illustrates the relationship between filmed wafer reflectance and wavelength at a specific incidence angle. The horizontal axis of the graph represents wavelength, whereas the vertical axis represents reflectance. The graph indicates that the light reflected from the wafer cannot readily be obtained due to a low reflectance when the wavelength is λ1, and that the reflected light can be obtained due to a high reflectance when the wavelength is λ2. This example indicates that the light reflected from the surface of the wafer 105 can be received to detect the vertical movement amount of the wafer 105 when the light source 120 contains a wavelength of λ2. In reality, the dependence of reflectance on wavelength varies with the film thickness and material of the wafer. It is therefore preferred that the second light source 120 contain white light or other light having a wide range of wavelengths or emit light delivering broadband wavelength coverage (from UV light to visible light having a wavelength of approximately 350 nm to 700 nm). The reason is that reflected light can be obtained within a wavelength region having a high reflectance because a wide range of wavelengths is contained. For example, a white laser, white light emitting diode, xenon lamp, mercury lamp, metal halide lamp, or halogen lamp may be used as a white light source. A polarization state of the light emitted from the second light source 120 may be selected as appropriate in accordance with the reflection characteristic of an inspection target. When, for instance, the light is unpolarized or circularly polarized, the film reflectance of the wafer is less dependent on the direction of polarization.

As described above, the light emitted from the second light source 120 is collected in the vicinity of the beam spot on the wafer 105 by a lens 121. The collected light is then reflected by the wafer 105 and collected by an optical sensor 123 via another lens 122. In this instance, a light source containing two or more different wavelengths is used as the light source 120. A two-element photodiode or other similar device capable of detecting a light collection position on a sensor is used as the optical sensor 123. When such a configuration is employed, the vertical movement amount of the wafer 105 is converted to the information on a light collection position on the optical sensor 123 by the optical lever principle so that the vertical movement amount (wafer surface height) prevailing near a beam spot position on the wafer 105 can be determined form an output from the optical sensor 123.

The output from the optical sensor 123 is forwarded to a controller 124 for the actuator 109. The controller 124 then generates a control signal. The control signal moves the actuator 109 to change the orientation of the mirror 107, which is an irradiation position correction optics, in accordance with the vertical movement of the wafer 105 (wafer surface height). The light emitted from the first light source 101 is then deflected by the mirror 107, which is an irradiation position correction optics, to make fine positional adjustments so that the oblique irradiation beam spot is placed in the same position as the vertical irradiation beam spot to correct the wafer in-plane movement of the oblique irradiation beam spot, which is caused by the vertical movement of the wafer 105. As a result, the light reception optics 110a-110d, 115a-115d can detect the scattered light based on the vertical irradiation beam spot and the scattered light based on the oblique irradiation beam spot from the same foreign matter and defects on the semiconductor wafer 105.

Effects of correcting the wafer in-plane movement of the oblique irradiation beam spot will now be described. If the surface of the semiconductor wafer 105 is warped, undulated, or otherwise deformed, the wafer surface moves vertically during an inspection. Therefore, the oblique irradiation beam spot moves in the wafer in-plane direction, thereby causing a position coordinate error as indicated in FIG. 5. It is assumed that oblique illumination light 90 falls on a wafer 501a at an elevation angle of θ to the wafer surface. If, for instance, the position of the wafer 501a moves to the position of a wafer 501b by a displacement amount of z due to deformation such as wafer in-plane undulation, the position at which the oblique irradiation light 90 hits the wafer surface moves by z/tan θ in the wafer in-plane direction. Consequently, the position coordinates of foreign matter and defects are rendered erroneous by such an amount between vertical irradiation and oblique irradiation. Thus, the controller 124 causes the optical sensor 123 to detect the amount of displacement z from wafer surface reference height, and drives the actuator 109 to correct the position of the oblique irradiation beam spot by z/tan θ for the purpose of controlling the deflection of the mirror 107, which is an irradiation position correction optics. This makes it possible to place the oblique irradiation beam spot at the same position as the vertical irradiation beam spot.

However, during oblique irradiation, the overall control section 140 can directly correct the position coordinates on the wafer 105, which are detected by the rotary stage 118 and uniaxial stage 119, with z/tan θ in accordance with the amount of displacement z from the wafer surface reference height, which is detected by the optical sensor 123, and without correcting the position of the oblique irradiation beam spot with the irradiation position correction optics.

As described above, it is possible to collate the information on foreign matter and defects on the wafer 105, which are detected within the same position coordinate system, during vertical irradiation and oblique irradiation. In this instance, however, it is practically impossible to exercise feedback control or feedforward control. Therefore, it is necessary to accurately determine the displacement amount z and oblique irradiation angle θ.

Thus, while the overall control section 140 spirally scans the semiconductor wafer 105 and emits laser light to form a vertical irradiation beam spot and an oblique irradiation beam spot, the light reception optics 110a-110d, 115a-115d can detect the information on scattered light, which arises from the same foreign matter and defects, within the same coordinate system on the semiconductor wafer 105. As a result, it is possible to collate the information obtained during vertical irradiation with the information obtained during oblique irradiation and detect extremely small foreign matter and defects with high reliability for inspection purposes.

The overall control section 140 is connected to the controller 124 for correcting the irradiation position of the oblique irradiation beam spot, the stage controller 125, the slider controller 127, and the signal processing section 130. The overall control section 140 acquires the information for spirally scanning the semiconductor wafer 105 from the stage controller 125, and transmits inspection start information and the like to the controllers 124, 125, 127. The overall control section 140 also acquires foreign matter/defect characteristic amount information (foreign matter/defect property information, foreign matter/defect position information, foreign matter/defect size information, etc.) related to inspection results from the signal processing section 130. Further, the overall control section 140 is connected to input means 141 for entering information on a semiconductor wafer and the like, a display device 142 for displaying a GUI and the like, and a storage device 143 for storing inspection condition information, inspection result information, and the like.

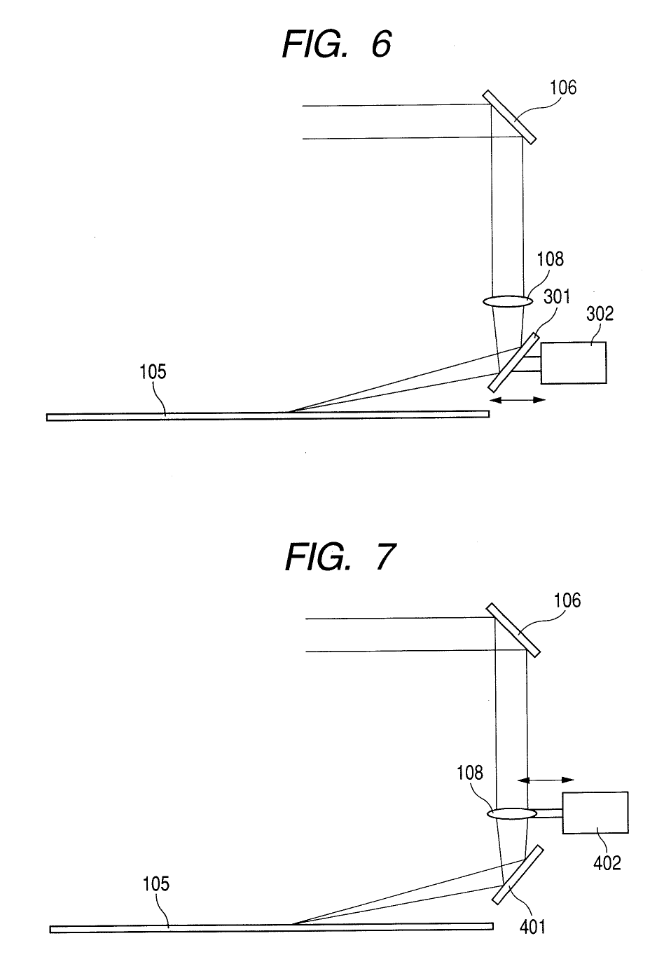

Modified versions of the irradiation position correction optics for the oblique irradiation beam spot according to the first embodiment will now be described with reference to FIGS. 6 and 7. FIG. 6 illustrates a first modified version of the irradiation position correction optics for the oblique irradiation beam spot. Light emitted from the first light source 101 falls on the oblique irradiation condenser lens 108 via the mirror 106. The light emitted from the condenser lens 108 is reflected by a mirror 301 and collected on the wafer 105. The mirror 301 is mounted on an actuator 302 that linearly moves in the direction in which the uniaxial stage 119 moves. The actuator 302 linearly moves the mirror 301 in accordance with vertical movement near the beam spot irradiation position on the wafer 105 detected by the optical sensor 123 and shifts the light emitted from the condenser lens 108 within the plane of incidence on the wafer 105. This movement corrects the irradiation position of the oblique irradiation beam spot that is displaced due to vertical movement from the reference height near the beam spot irradiation position on the wafer 105, and adjusts the position of the oblique irradiation beam spot for that of the vertical irradiation beam spot. In this instance, the mirror 301 may move in horizontal direction, vertical direction, or any other direction as far as it moves within the plane of light incidence on the wafer 105.

FIG. 7 illustrates a second modified version of the irradiation position correction optics for the oblique irradiation beam spot. Light emitted from the first light source 101 falls on the oblique irradiation condenser lens 108 via the mirror 106. The light emitted from the condenser lens 108 is reflected by a mirror 401 and collected on the wafer 105. The condenser lens 108 is mounted on an actuator 402 that linearly moves in the direction in which the uniaxial stage 119 moves. The actuator 402 linearly moves the condenser lens 108 in accordance with vertical movement near the beam spot irradiation position on the wafer 105 detected by the optical sensor 123 and shifts the light emitted from the condenser lens 108 within the plane of incidence on the wafer 105. This movement corrects the irradiation position of the oblique irradiation beam spot that is displaced due to vertical movement from the reference height near the beam spot irradiation position on the wafer 105, and adjusts the position of the oblique irradiation beam spot for that of the vertical irradiation beam spot. In this instance, the condenser lens 108 may move in any direction as far as it moves within the plane of light incidence on the wafer 105 and in a direction that is not parallel to its optical axis. For example, the condenser lens 108 may move in a direction that is perpendicular to its optical axis. Further, the positions of the condenser lens 108 and mirror 401 may be interchanged.

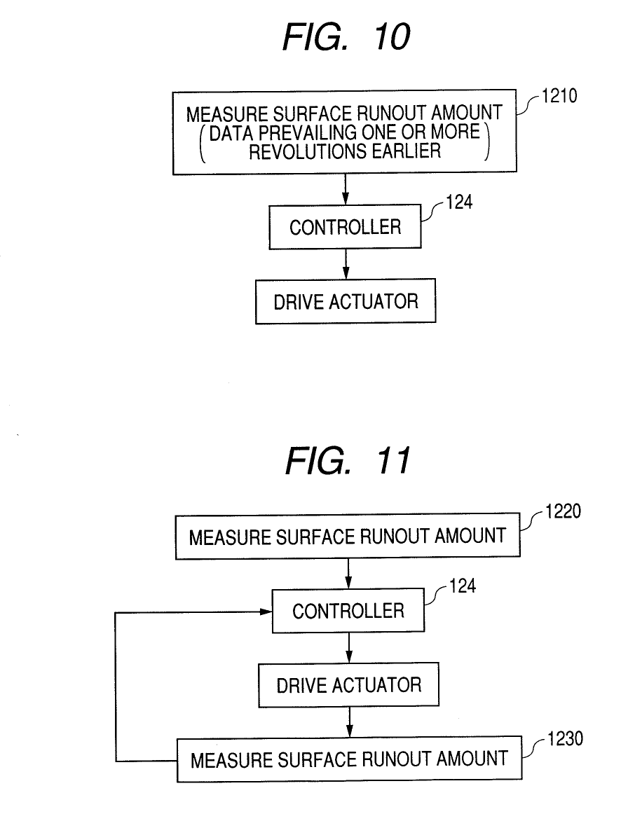

A method for controlling the actuator of the irradiation position correction optics will now be described with reference to FIGS. 10 and 11. A feedforward control method may be used for controlling the actuator 109, 302, or 402 of the irradiation position correction optics. This method uses the vertical movement information that prevails one or more wafer revolutions earlier near the beam spot irradiation position on the wafer. When the feedforward control method is used, the signal flows as indicated in FIG. 10. In this instance, the controller 124 exercises drive control over the actuator 109, 302, or 402 of the irradiation position correction optics by using surface runout amount measurement data (vertical movement information prevailing one or more wafer revolutions earlier) 1210 that is detected by the optical sensor 123 and stored in a memory (not shown) within the controller 124 or in the storage device 143 via the controller 124. When this method is used, the displaced position of the oblique irradiation beam spot can be corrected without delay by applying to the actuator a control signal that is shifted accordingly in terms of time even if the actuator's phase characteristic is delayed by a known amount.

If the delay in the phase characteristic of the actuator is sufficiently small, the displaced position of the oblique irradiation beam spot can be corrected by exercising feedback control to apply real-time wafer vertical movement information to the actuator. When such a feedback control method is used, the signal flows as indicated in FIG. 11. In this instance, the controller 124 exercises drive control over the actuator 109, 302, or 402 of the irradiation position correction optics by using surface runout amount measurement data 1220 that is detected by the optical sensor 123. At the same time, the controller 124 acquires surface runout amount measurement data 1230 that is detected by the optical sensor 123. From next time on, the controller 124 exercises drive control over the actuator 109, 302, or 402 by using the acquired surface runout amount measurement data 1230. The use of this control method, which employs a real-time signal, makes it possible to use more accurate wafer vertical movement information.

When the second light source 120 irradiates the vicinity of the beam spot irradiation position on the wafer 105 with light containing a broadband wavelength component or white light to detect vertical movement (the amount of deformation, which is displacement), which is caused by wafer deformation from the reference height, by using the light reflected from the vicinity, the first embodiment, which has been described above, can accurately detect wafer deformation without being affected by the film quality of a wafer surface layer. As a result, the position of the oblique irradiation beam spot can be accurately adjusted for that of the vertical irradiation beam spot by positively moving the oblique irradiation beam spot within the wafer plane in accordance with the accurately detected wafer surface deformation information and correcting the positional displacement of the oblique irradiation beam spot, which is caused by wafer surface deformation. Therefore, when laser light is emitted to form a vertical irradiation beam spot and an oblique irradiation beam spot while the semiconductor wafer 105 is spirally scanned, the light reception optics 110a-110d, 115a-115d can detect the information on scattered light, which arises from the same foreign matter and defects, within the same coordinate system on the semiconductor wafer 105. Consequently, it is possible to collate the information detected during vertical irradiation with the information detected during oblique irradiation, and detect extremely small foreign matter and defects with high reliability for inspection purposes.

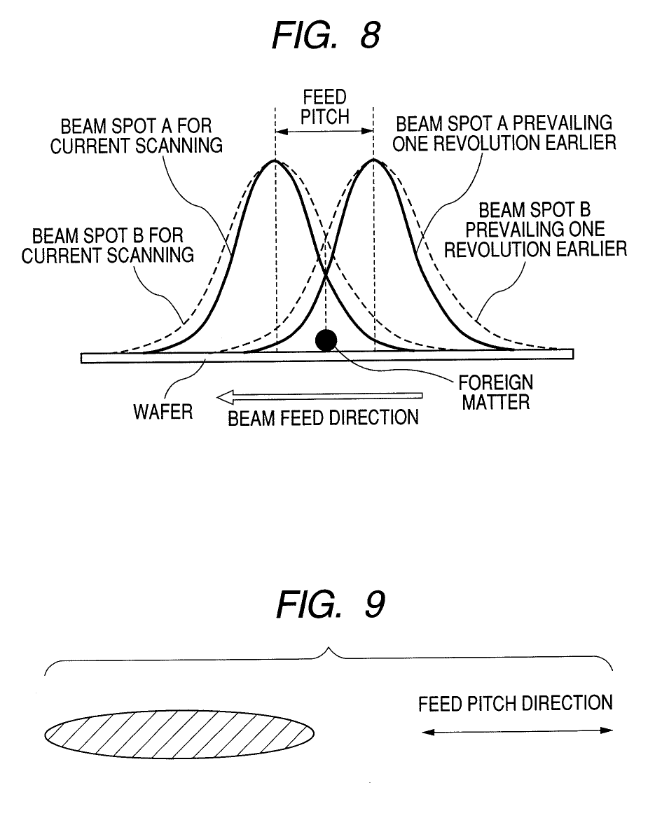

Further, since the beam spot spirally scans the surface of the semiconductor wafer 105, the uniaxial stage 119 feeds the beam spot at a fixed feed pitch between beam spot B prevailing one revolution earlier and beam spot B used for current scanning as shown in FIG. 8. Meanwhile, foreign matter and defects arise at arbitrary positions. Therefore, no matter whether the beam spot is derived from vertical irradiation or oblique irradiation, it is necessary to provide irradiation so that no discontinuity occurs within an inspection range and that beam spot B prevailing one revolution earlier and beam spot B used for current scanning overlap in the vicinity of the spot. Consequently, it is preferred that the irradiation intensity be increased by enlarging the beam spot in the radial direction of the semiconductor wafer (in the feed direction of the uniaxial stage 119) and reducing the beam spot in the direction perpendicular to the radial direction of the semiconductor wafer as shown in FIG. 9. For vertical irradiation beam spot formation, therefore, a laser beam whose diameter is increased by the beam expander 102 is rendered elliptical by the beam shaping optics 200 to form a beam spot that is shaped as described above. For oblique irradiation beam spot formation, in consideration of the fact that the beam spot spreads in the feed direction due to oblique irradiation, a laser beam whose diameter is increased by the beam expander 102 is rendered elliptical by the beam shaping optics 201 to form a beam spot that is shaped as described above. The beam shaping optics 200, 201, which reduce or enlarge the beam spot diameter in one direction only (e.g., in the direction of a major or minor axis as indicated in FIG. 9), are called anamorphic optics. It is generally known that a prism method or cylindrical lens method is used for anamorphic optics configuration. As described above, when beam spots that have the same shape and are enlarged in the feed pitch direction as shown in FIG. 9 are formed by vertical irradiation and oblique irradiation, foreign matter and defects can be properly detected without incurring any loss within an inspection range and without regard to the positions of the foreign matter and defects.

### Second Embodiment

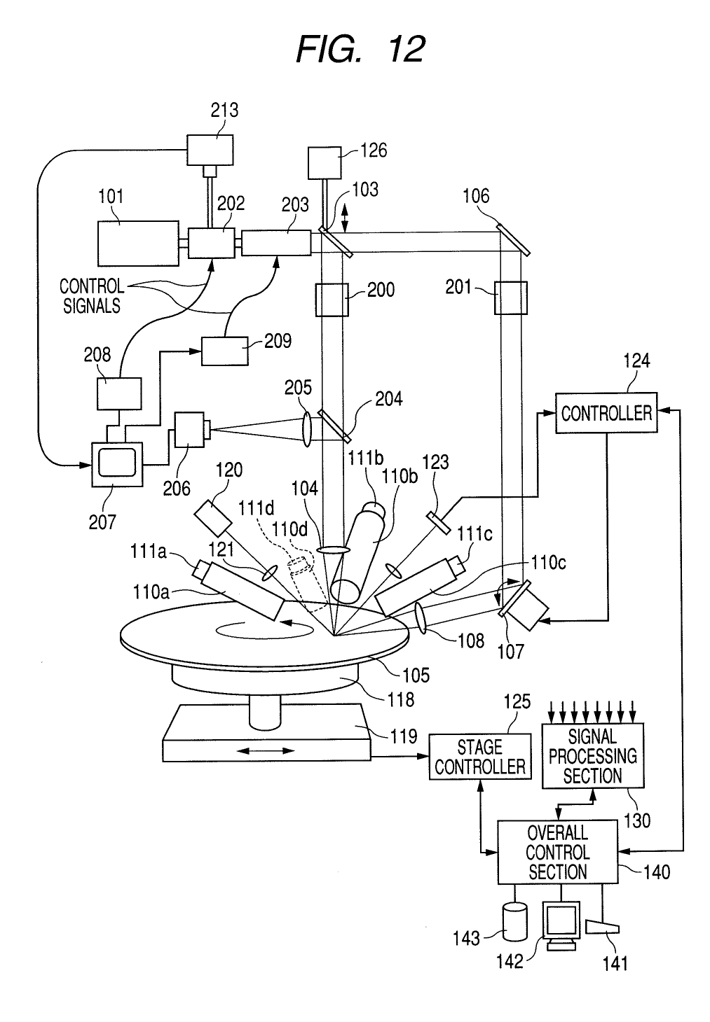

A second embodiment of the present invention will now be described with reference to FIG. 12. The second embodiment differs from the first embodiment in that the former includes observation optics 204-207, which observe the position and shape (illumination distribution included) of a beam spot image formed on the wafer; a beam correction optics 202, which corrects the tilt (gradient: emission direction) and shift (displacement: emission position) of a beam emitted from the first light source 101 relative to the optical axis; a controller 208, which controls the beam correction optics 202 in accordance with the position and shape of the beam spot image observed by the observation optics 204-207; and a controller 209, which controls a zoom type beam expander (beam diameter enlargement optics) 203 in accordance with the position and shape of the beam spot image observed by the observation optics 204-207. It should be noted that the slider controller 127 is not shown in FIG. 12.

Light emitted from the first light source 101 falls on the beam correction optics 202 in which the tilt (gradient) and shift (displacement) relative to the optical axis are corrected. As described later, the beam correction optics 202 incorporates a camera 213. The tilt and shift information on the beam is obtained from an output of the camera 213. A beam emitted from the beam correction optics 202 falls on the zoom type beam expander 203, which can vary the magnification. The beam emitted from the zoom type beam expander 203 bounces off the controllable mirror 103, travels through the beam shaping optics 200, beam splitter 204, and vertical irradiation condenser lens 104, and falls on the wafer 105 from a substantially vertical direction to form a vertical irradiation beam spot. The vertical irradiation beam spot image produced on the wafer 105 is formed in an image pickup plane of the camera 206 by the condenser lens 104, which is an observation optics, the beam splitter 204, and an image formation optics that is composed of an image formation lens 205, picked up by the camera 206, and entered into an image processing section (not shown) within a monitor 207 for storage purposes. The image processing section detects the positional displacement and dimensions (diameters) (including the major and minor axis lengths shown in FIG. 9) of the beam spot relative to the optical axis of the vertical irradiation condenser lens 104 by using the observed vertical irradiation beam spot image, and makes it possible to observe the position and shape (including the illumination distribution) of the vertical irradiation beam spot image.

While the controllable mirror 103 is retracted, the beam emitted from the zoom type beam expander 203 travels to the mirror 106, beam shaping optics 201, mirror 107, and oblique irradiation condenser lens 108 in order named, and then falls on the wafer 105 from an oblique direction to form an oblique irradiation beam spot. The oblique irradiation beam spot image is formed in an image pickup plane of the camera 206 by the condenser lens 104, which is an observation optics, the beam splitter 204, and the image formation optics that is composed of the image formation lens 205, picked up by the camera 206, and entered into the image processing section (not shown) in the monitor 207 for storage purposes. As is the case with vertical irradiation, the image processing section detects the positional displacement and dimensions (diameters) (including the major and minor axis lengths shown in FIG. 9) of the beam spot relative to the optical axis of the vertical irradiation condenser lens 104 by using the observed oblique irradiation beam spot image, and makes it possible to observe the position and shape (including the illumination distribution) of the oblique irradiation beam spot image.

A camera that uses a CCD, CMOS, or other similar image sensor may be employed as the camera 206.

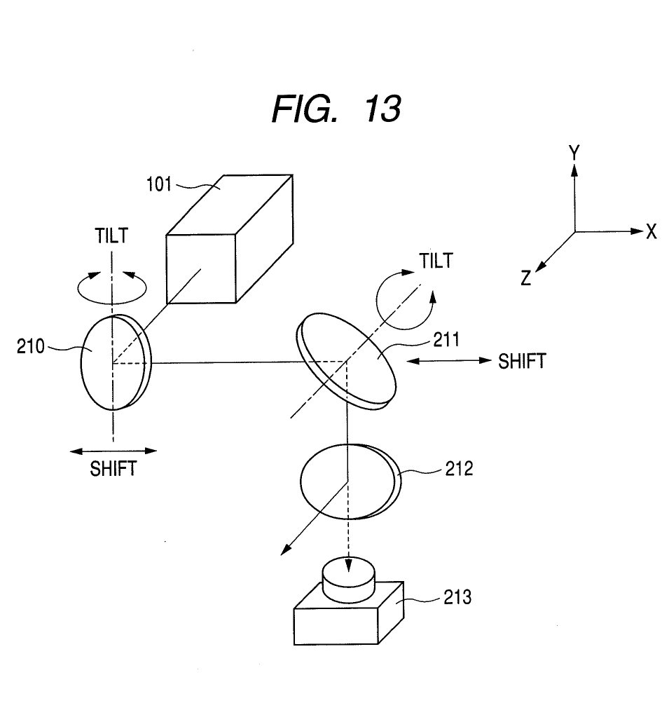

The configuration of the beam correction optics 202 will now be described in detail with reference to FIG. 13. The light emitted from the first light source 101 travels in the Z-axis direction as viewed in the figure. The light then bounces off a mirror 210 in the X-axis direction, and travels within the XZ plane at a deflection angle of 90 degrees. Next, the light bounces off a mirror 211 downward along the Y-axis and travels within the XY plane at a deflection angle of 90 degrees. The light is then deflected again by angle of 90 degrees by a mirror 212, and emitted in the Z-axis direction. The mirror 210 is capable of tilting the light around the Y-axis and shifting the light in the X direction. The mirror 211 is capable of tilting the light around the Z-axis and shifting the light in the X direction. The mirror 212 is stationary. Therefore, the tilt and shift of the beam emitted from the first light source 101 can be corrected by tilting and shifting the mirror 210 and mirror 211. The order of deflection is changeable. The position of the mirror 212 is not limited and may be determined in accordance with the subsequent optical path configuration.

The light that is transmitted through the mirror 212 directly falls on the light receiving surface of the camera 213. Therefore, the tilt and shift information on the beam is obtained from an image that is output from the camera 213. A camera that uses a CCD, CMOS, or other similar image sensor may be employed as the camera 213.

The beam correction optics 202 uses the beam image of the camera (beam detection means) 213 and the beam spot image observed by the observation optics (beam spot detection means comprises at least observation optics 204 to 206) 204-207 to correct the tilt (gradient) and shift (displacement) of the beam emitted from the first light source 101 relative to the optical axis so that the beam spot on the wafer surface is placed at the reference position predetermined for vertical irradiation/oblique irradiation. In such an instance, the correction may be made manually or semiautomatically while viewing the monitor 207 to observe a beam spot image 161 that is picked up by the camera 206 and a beam monitor image 162 that is picked up by the camera 213. An alternative is to use the beam correction optics 202 as an automatic device, deliver to the controller 208 of the beam correction optics 202 an image signal output representing, for instance, the positional displacement of the beam spot, which is detected by using the beam spot image observed by the image processing section in the monitor 207, and make corrections by controlling the beam correction optics 202 in accordance with the image signal output.

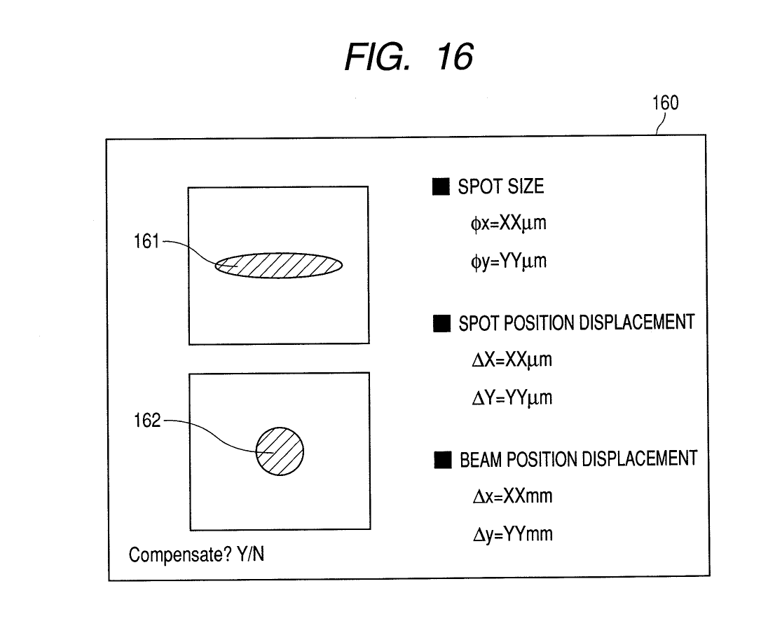

The beam spot monitor image 161 and beam image 162 shown in FIG. 16 should be used as described below. The beam spot monitor image 161 is an image of the focal plane of the condenser lens 104 or 108. Therefore, when the beam is tilted, the spot position moves. However, when the beam is shifted, the spot position does not move. The beam tilt can be corrected by tilting the spot position on the image 161. Next, the beam shift can be corrected by shifting the beam position on the beam image 162.

The zoom type beam expander 203 uses the beam spot image observed by the observation optics 204-207 to correct the beam magnification so that the dimensions of the beam spot on the wafer surface coincide with the dimensions predetermined for vertical irradiation/oblique irradiation. In such an instance, the correction may be made manually or semiautomatically while viewing the monitor 207 to observe the beam spot image picked up by the camera 206. An alternative is to use the zoom type beam expander 203 as an automatic device, deliver to the controller 209 of the zoom type beam expander 203 an image signal output representing, for instance, the dimensions of the beam spot, which is detected by using the beam spot image observed by the image processing section in the monitor 207, and make corrections by controlling the zoom type beam expander 203 in accordance with the image signal output.

A single controller may be used to perform the function of the beam correction optics controller 208 and the function of the beam expander controller 209. Further, the display device 142 connected to the overall control section 140 may be used as the monitor 207. In such an instance, a CPU in the overall control section 140 may alternatively execute image processing, which is normally executed by the image processing section (not shown) in the monitor 207.

Effects of correcting the tilt and shift of a beam emitted from the first light source will now be described. The emitted beam may be shifted and tilted due to the characteristics of the first light source so that the spot position on the wafer surface may move. When, for instance, a laser light source is used, the beam may be shifted and tilted due to a shift of an employed internal crystal or due to a temperature characteristic. Therefore, if an inspection is continuously conducted without knowledge of beam spot positional displacement on the wafer, which is caused by the above-mentioned variations, the position coordinates are in error. Under such circumstances, the shift and tilt of the emitted beam are checked periodically by observing the beam spot image with the observation optics (the beam spot detection means comprises at least the observation optics 204 to 206) 204-207 and by observing the beam image with the camera (beam detection means) 213. If the tolerance is exceeded, the error in the coordinates of detected foreign matter and defects on the wafer can be minimized by making corrections. As a result, it is possible to enhance the accuracy in the detection of foreign matter and defects.

Effects of correcting the beam spot dimensions will now be described. A spiral beam spot scan is run during an inspection. However, the beam spot is radially fed at such a pitch that the beam spot used for current scanning partly overlaps with a part of the beam spot prevailing one revolution earlier. This beam spot feed operation is performed to avoid a loss within an inspection range. This operation is shown in FIG. 8. As is obvious from FIG. 8, the intensity of light scattered from foreign matter varies depending on what part of the beam spot the foreign matter passes. The maximum value occurs when the foreign matter passes the center of the beam spot. The minimum value occurs when the foreign matter passes the intersection of the beam spot prevailing one revolution earlier and the beam spot used for current scanning. Therefore, if the beam spot dimensions vary, the illumination light intensity at the intersection varies to vary the intensity of light scattered from the foreign matter passing through the intersection. For example, since beam spot A and beam spot B differ in the intersection height as shown in FIG. 8, these beam spots differ in the scattered light intensity minimum value. The beam spot dimensions vary because the beam diameter of the first light source 101 varies. Meanwhile, since the employed beam diameter of the first light source 101 varies from one inspection apparatus to another, the illumination light intensity prevailing at the beam spot intersection also varies from one apparatus to another. Thus, the beam diameter variations of the light source result in the detection sensitivity variations among the apparatuses. Therefore, the variations among the apparatuses can be minimized when the zoom type beam expander 203 corrects the beam spot dimensions by using the beam spot image observed by the observation optics 204-207.

As the specimen for observing the beam spot image, a substitute made of a different material such as a ceramics board may be used instead of the wafer 105. The material is acceptable as far as its surface scatters light to such an extent that a beam spot image derived from oblique irradiation is visible. An appropriate material may be selected while viewing the quality of a beam spot image that is picked up by the camera 206. Further, the surface targeted for irradiation may be at the same height as the reference wafer surface.

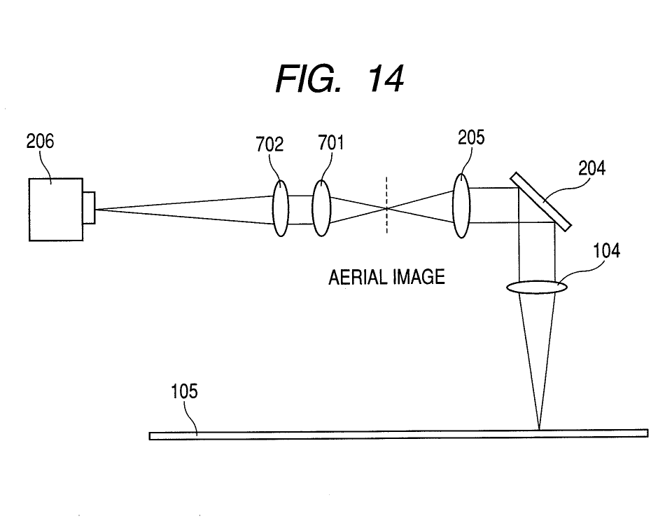

Another embodiment of the observation optics will now be described with reference to FIG. 14. In the configuration shown in FIG. 12, the beam spot image, which is created by the vertical irradiation condenser lens 104 and image formation lens 205 via the beam splitter 204, is directly formed in an image pickup plane of the camera 206. In the configuration shown in FIG. 14, however, the beam spot image created by the vertical irradiation condenser lens 104 and image formation lens 205 is an aerial image and formed in the image pickup plane of the camera 206 via the lens 701 and lens 702. The use of this configuration makes it possible to achieve a proper image magnification by selecting the lens 701 and lens 702 as appropriate.

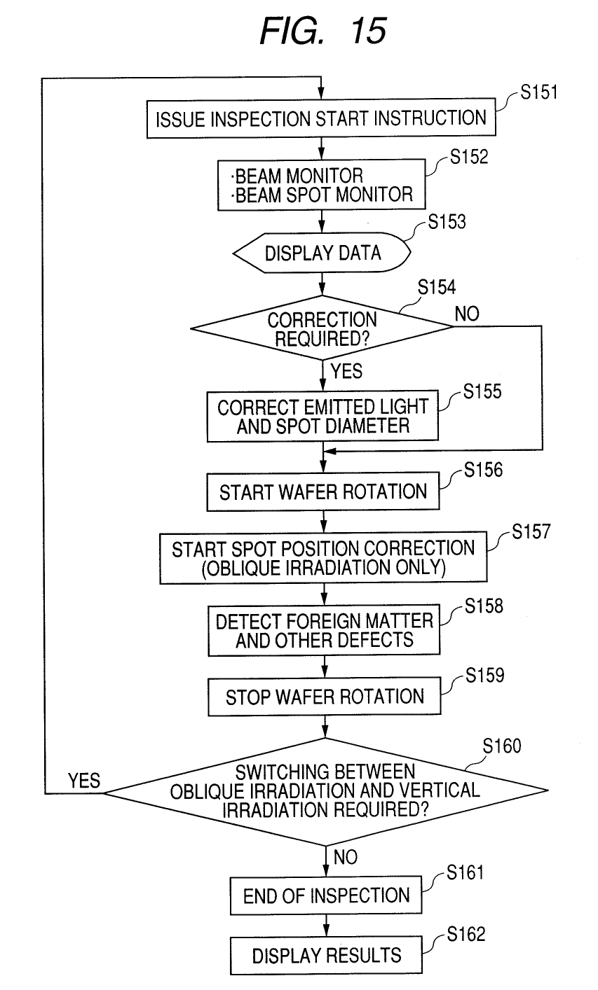

The second embodiment of the present invention, which has been described above, exercises a function for correcting the oblique irradiation beam spot position, an emitted beam correction function for correcting the emission direction (tilt) and emission position (shift) of the beam emitted from the first light source, and a function for allowing the beam expander to correct the beam magnification as indicated, for instance, in a flowchart in FIG. 15. When, at the beginning of an inspection, an inspection start instruction is issued (step S151) with the wafer 105 loaded onto the stages 118, 119 of the inspection apparatus, the beam spot image projected onto the wafer 105 is observed by the observation optics 204-207 and displayed as the monitor image 161 (step S152). At the same time, the beam monitor image 162 picked up by the camera 213 is displayed. The operator can view these monitor images 161, 162, for instance, in a GUI screen 160 on the monitor 207 as shown in FIG. 16. Further, the data about spot positional displacement (ΔX,ΔY), spot size (spot diameter) (φx,φy), beam positional displacement (Δx,Δy), and the like, which are detected, for instance, by the image processing section (not shown) in the monitor 207, are displayed in the GUI screen 160 (step S153), and transmitted to the controllers 208, 209. When the employed configuration is such that the entire image observed by the observation optics 204-207 is transmitted to the overall control section 140, the image can be displayed in the GUI screen 160 on the display device 142. Further, the data about spot positional displacement (ΔX,ΔY), spot size (spot diameter) (φx,φy), beam positional displacement (Δx,Δy), and the like can be detected by the CPU in the overall control section 140 and transmitted to the controllers 208, 209. The controllers 208, 209 check the data to judge whether corrections are needed (step S154). If the obtained judgment result indicates that corrections are needed, the controllers 208, 209 control the beam correction optics 202 in accordance with the data to correct the emission direction (tilt) and emission position (shift) of the beam, and control the beam expander 203 to correct and fix the beam magnification (step S155). In such an instance, the correction necessity judgment and correction operations may be performed in accordance with instructions entered by the operator via the GUI or fully automatically performed in accordance with a prepared program and without operator intervention. Further, the emitted beam may be allowed to fall on another reference surface, which is separate from the wafer surface made, for instance, of a ceramics board, and the resulting image may be used to correct the emitted beam and beam magnification.

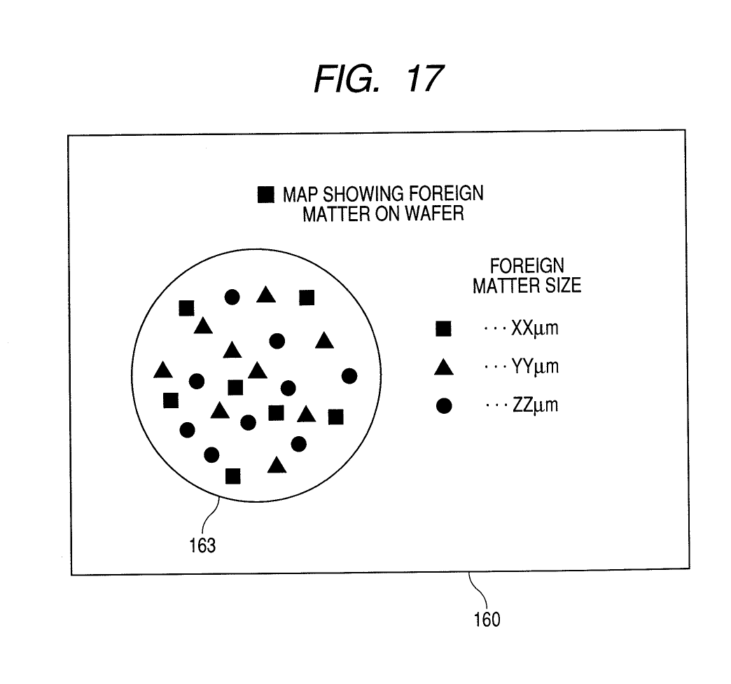

Next, the wafer begins to rotate so that the beam spot spirally scans the wafer surface (step S156). If the inspection is based on oblique irradiation, step 157 is performed to start correcting the beam spot position in accordance with the vertical movement of the wafer, which is detected by the optical sensor 123. Further, step S158 is performed to detect defects. When the entire wafer surface is completely inspected, the wafer stops rotating (step S159). Next, step S160 is performed in accordance with an inspection target to judge whether it is necessary to change the direction of irradiation. If it is not necessary to change the direction of irradiation, the inspection is terminated (step S161). If, on the other hand, it is necessary to change the direction of irradiation, an inspection start instruction is issued with the controllable mirror 103 retracted to change the direction of irradiation (step S151), and an inspection is performed with a new irradiation direction employed. When the inspection is completed (step S161), the overall control section 140 collates the inspection results of the same position coordinates for both irradiation directions. As a result of such collation, the sizes and types of foreign matter and other defects are identified and displayed together with their position coordinates, for instance, by the GUI of the display device 142 as shown in FIG. 17 (step S162).

In the flow described above, the emitted beam and beam magnification are corrected immediately before the start of inspection. However, the present invention is not limited to the use of such a method. Real-time corrections may be made during an inspection by using scattered light and reflected light from the wafer. Further, the present invention is not limited to the use of the flow described above in which various operations are performed in a predetermined sequence. If necessary, it is possible to interchange the described operations, add new operations, and omit some of the described operations.

### Third Embodiment

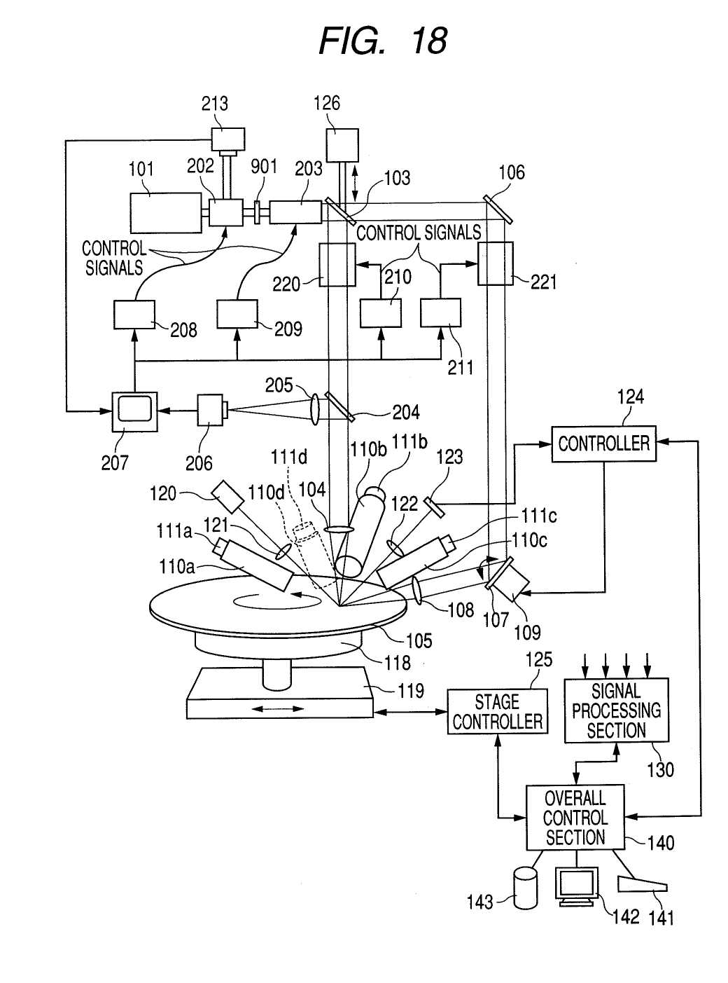

A third embodiment of the present invention will now be described with reference to FIG. 18. The third embodiment differs from the second embodiment in that the former includes magnification adjustment/beam shaping optics 220, 221 and a beam spot profile correction element 901. It should be noted that the slider controller 127 is not shown in FIG. 18 either.

The beam emitted from the first light source 101 falls on the beam correction optics 202, which corrects the tilt and shift relative to the optical axis. The beam emitted from the beam correction optics 202 travels through the profile correction element 901 and falls on the zoom type beam expander 203. The beam emitted from the zoom type beam expander 203 bounces off the controllable mirror 103, travels through the magnification adjustment/beam shaping optics 220, beam splitter 204, and vertical irradiation condenser lens 104, and falls on the wafer 105 from a substantially vertical direction to form a vertical irradiation beam spot. The vertical irradiation beam spot image formed on the wafer 105 is formed in the image pickup plane of the camera 206 by the condenser lens 104, which is an observation optics, the beam splitter 204, and the image formation optics that is composed of the image formation lens 205, picked up by the camera 206, and entered into the image processing section (not shown) in the monitor 207 for storage purposes. The image processing section detects the positional displacement and dimensions (diameters) (including the major and minor axis lengths shown in FIG. 9) of the beam spot relative to the optical axis of the vertical irradiation condenser lens 104 by using the observed oblique irradiation beam spot image, and makes it possible to observe the position and shape (including the illumination distribution) of the vertical irradiation beam spot image.

While the controllable mirror 103 is retracted, the beam emitted from the zoom type beam expander 203 travels to the mirror 106, magnification adjustment/beam shaping optics 221, mirror 107, and oblique irradiation condenser lens 108 in order named, and then falls on the wafer 105 from an oblique direction to form an oblique irradiation beam spot. The oblique irradiation beam spot image is formed in the image pickup plane of the camera 206 by the condenser lens 104, which is an observation optics, the beam splitter 204, and the image formation optics that is composed of the image formation lens 205, picked up by the camera 206, and entered into the image processing section (not shown) in the monitor 207 for storage purposes. The image processing section detects the positional displacement and dimensions (diameters) (including the major and minor axis lengths shown in FIG. 9) of the beam spot relative to the optical axis of the vertical irradiation condenser lens 104 by using the observed oblique irradiation beam spot image, and makes it possible to observe the position and shape (including the illumination distribution) of the oblique irradiation beam spot image.

The operation performed by the beam correction optics 202 will not be described again because it is the same as described in conjunction with the second embodiment. The zoom type beam expander 203 and magnification adjustment/beam shaping optics 220, 221 correct the magnification (reduction or enlargement) of the zoom type beam expander 203 and the magnification (reduction or enlargement) of the magnification adjustment/beam shaping optics 220, 221 by using the beam spot image observed by the observation optics 204-207 so that the long and short diameters of the beam spot on the wafer surface are as predetermined for vertical irradiation and oblique irradiation. In such an instance, the correction may be made manually or semiautomatically while viewing the TV monitor 207 to observe the image picked up by the camera 206. An alternative is to use the beam expander 203 and magnification adjustment/beam shaping optics 220, 221 as automatic devices, deliver to the controllers 209, 220, 221 an image signal output representing the dimensions of the beam spot, which is detected by using the beam spot image observed by the image processing section in the monitor 207, and correct the magnification (reduction or enlargement) by controlling the beam expander 203 and magnification adjustment/beam shaping optics 220, 221 in accordance with the image signal output.

Alternatively, a single controller may be used to perform the function of the beam correction optics controller 208, the function of the beam expander controller 209, and the functions of the magnification adjustment/beam shaping optics controllers 210, 211. Further, the display device 142 connected to the overall control section 140 may be used as the monitor 207. In such an instance, the CPU in the overall control section 140 may alternatively perform an image process that is normally performed by the image processing section (not shown) in the monitor 207.

Effects of using a magnification adjustment type beam shaping optics will now be described. When the beam shaping optics 220, 221 are capable of adjusting the magnification in addition to the zoom type beam expander 203, the beam spot diameter can be adjusted in two directions that are perpendicular to each other. More specifically, the zoom type beam expander 203 first adjusts the short diameter of the beam spot, and then the magnification adjustment/beam shaping optics 220, 221 adjust the long diameter.

The intensity of light scattered from foreign matter and defects is proportional to the illumination intensity within the beam spot. Meanwhile, the illumination intensity is in inverse proportion to the area of the beam spot. Therefore, to obtain the same scattered light intensity in the case where the spot area varies due to beam spot diameter variations, it is necessary to adjust the beam power. In this case, if the beam spot area increases due to its variations, it is necessary to use greater power for irradiation in order to obtain the same scattered light intensity. In this instance, however, the power cannot be sufficiently raised unless the light source capacity is more than adequate so that it may be practically impossible to obtain necessary scattered light intensity. Consequently, the detection sensitivity is lowered.

Under the above circumstances, the beam spot area should be changed in order to obtain the same scattered light intensity without raising the power. In this instance, the same illumination intensity can be obtained when the zoom type beam expander 203 changes the long and short diameters of the beam spot at the same ratio. In this case, however, the intersection of the beam spot used for current scanning and the beam spot prevailing one revolution earlier does not always have the same height. If the intersection height varies, the detection sensitivity varies from one apparatus to another as described earlier. Meanwhile, if the magnification (reduction or enlargement) can be adjusted in two directions (in the directions of long and short diameters), the same illumination intensity can be adjusted while maintaining the intersection height when the long and short diameters are individually adjusted to predetermined values. When the beam shaping optics 220, 221 capable of adjusting the magnification are employed to adjust the beam spot diameters in two directions for magnification adjustment purposes, it is possible to minimize the variations from one apparatus to another.

The present invention includes a spot diameter correction optics (203, 220, or 221), which enlarges or reduces the diameter of the beam spot formed on the wafer surface in at least one direction (in the direction of the long or short axis) for correction purposes in accordance with the information on at least the dimensions of the vertical irradiation beam spot or oblique irradiation beam spot detected by the beam spot detection means 204-207.

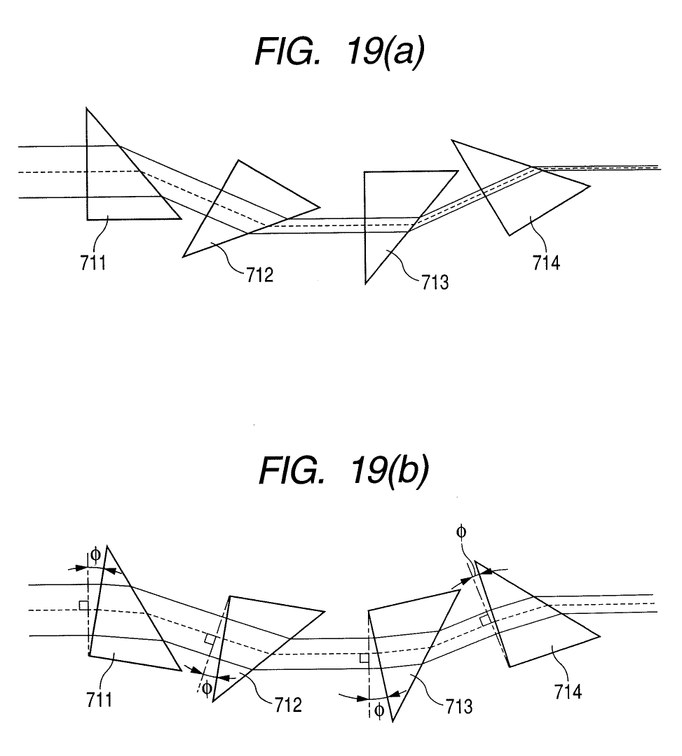

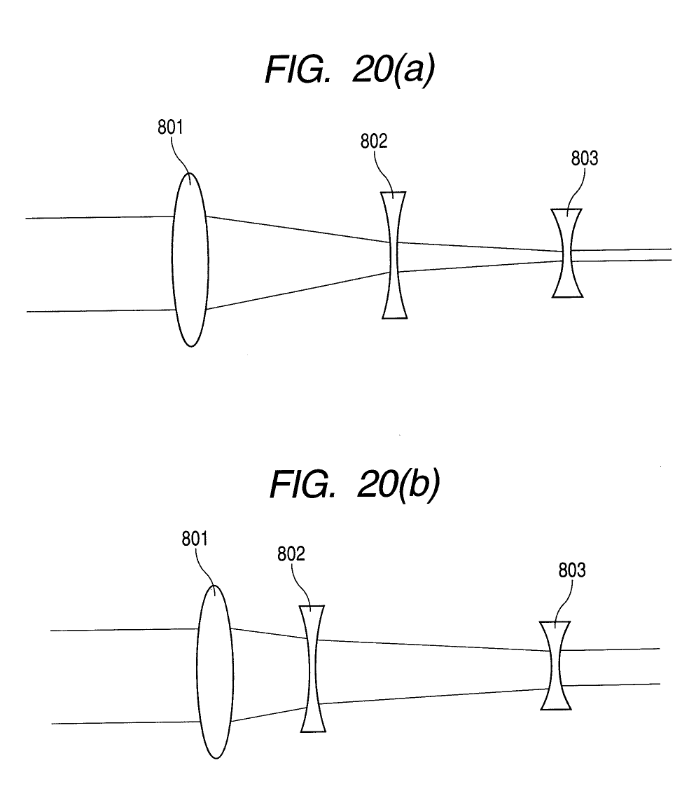

The first and second embodiments of the magnification adjustment/beam shaping optics will now be described in detail with reference to FIGS. 19 and 20. FIGS. 19A and 19B illustrate a prism system that is a specific example of the magnification adjustment/beam shaping optics according to the first embodiment. It comprises, for instance, four prisms 711-714 having the same shape. Referring to FIG. 19A, the beam emitted from the light source falls on prism 711 from the left-hand side of the figure, travels through prisms 712 and 713, and is emitted from prism 714. Meanwhile, the beam diameter in the plane of the paper decreases due to the refraction of each prism. The magnification is adjusted by rotating the prisms. When the above adjustment is made, the reduction ratio, which is provided by the refraction of each prism, varies as shown in FIG. 19B. Therefore, the reduction ratio can be changed. When the prisms rotate, the angle of light incidence on each prism varies. In this instance, however, the rotation angle for providing the same incidence angle for all prisms is preferably selected (note the angle φ in the figure). This ensures that the prisms provide the same light deviation angle. Therefore, deviation angle offsetting occurs between two prisms so that the direction of light emission from prism 714 remains unchanged after magnification adjustment.

The first embodiment assumes that four prisms are used for configuration. However, the prevent invention does not particularly limit the number of prisms. From the viewpoint of deviation angle offsetting, it is preferred that an even number of prisms be used for configuration. When the number of prisms is a multiple of 4, the incoming light and outgoing light can be aligned with the same optical axis as described in conjunction with the first embodiment. Further, it also makes it easy to arrange optical parts. Alternatively, the employed configuration may include a plurality of variously shaped prisms.

FIGS. 20A and 20B illustrate a cylindrical lens system according to the second embodiment of the magnification adjustment/beam shaping optics. It comprises, for instance, three cylindrical lenses. Referring to FIG. 20A, the beam emitted from the light source falls on a convex cylindrical lens 801 from the left-hand side of the figure, travels through a concave cylindrical lens 802, and is emitted from another concave cylindrical lens 803. Meanwhile, the beam diameter in the plane of the paper decreases due to the refraction of each lens. Since the cylindrical lenses 801, 802, 803 do not have a curvature in the plane perpendicular to the paper surface, the beam diameter does not change in the plane perpendicular to the paper surface. The magnification is adjusted by changing the spacing intervals between the cylindrical lenses. When the above adjustment is made, the reduction ratio varies as shown in FIG. 20B.

The second embodiment assumes that three cylindrical lenses are used for configuration. However, the prevent invention does not particularly limit the number of cylindrical lenses.

Another embodiment of the zoom type beam expander 203 will now be described. The zoom type beam expander 203 may be a beam shaping optics that is configured the same as shown in FIGS. 19A and 19B or 20A and 20B. In this instance, it is assumed that light comes from the right-hand side of FIGS. 19A and 19B or 20A or 20B in the employed configuration. First of all, the beam emitted from the first light source 101 is enlarged in one direction only. The emitted beam is enlarged in the direction perpendicular to the beam shaping optics 220, 221. Next, the beam shaping optics 220, 221 enlarge or reduce the beam in a direction that is perpendicular to the aforementioned direction. Consequently, the beam spot diameter can be adjusted in two directions that are perpendicular to each other.

Effects of the profile correction element 901 will now be described. When the profile correction element 901 is used to adjust the beam spot profile for an ideal Gaussian distribution, the possibility of foreign matter/defect detection coordinate error can be reduced. The reason is that foreign matter/defect position coordinates are detected on the assumption that the beam spot profile is a Gaussian distribution.

An ideal beam spot shape is an elongated oval as shown in FIG. 9. The major axis of the beam spot is in the radial direction (beam speed feed direction) around a wafer rotation axis, and the minor axis is in the tangential direction. Ideally, the profile of the beam spot is a Gaussian distribution in both directions.

The beam spot crossing foreign matter and defects will now be considered. The light scattered from foreign matter varies with time when the beam spot crosses the foreign matter. The scattered light is locally maximized when the center in the direction of the minor axis is reached. The resulting local maximal value varies depending on where in the direction of the major axis of the beam spot the foreign matter/defect passes. The local maximal value is maximized when the foreign matter/defect crosses the center in the direction of the major axis. When the foreign matter coordinates are to be indicated by polar coordinates (r,θ) whose origin is the wafer rotation axis, the θ coordinate can be determined by the θ value prevailing when the scattered light is locally maximized. However, the r coordinate cannot be determined. The reason is that the above is not adequate for determining where in the direction of the major axis of the beam spot the foreign matter/defect passes. As shown in FIG. 8, determination is accomplished when the light scattered from the same foreign matter is detected twice by feeding the beam spot in the radial direction in such a manner as to invoke partial overlap.

First of all, the beam spot profile in the direction of the major axis is determined in accordance with a Gaussian distribution equation. Next, the ratio between the scattered light intensity that concerns the same foreign matter and prevails during the scan performed one revolution earlier and the scattered light intensity prevailing during a real-time scan is determined. The r coordinate is then determined by substituting the determined ratio and feed pitch amount into the Gaussian distribution equation, which expresses the profile. Therefore, if the profile of the actual beam spot does not agree with the Gaussian distribution, the calculated r coordinate value is incorrect. This problem can be solved by readjusting the profile for the Gaussian distribution with the profile correction element 901.

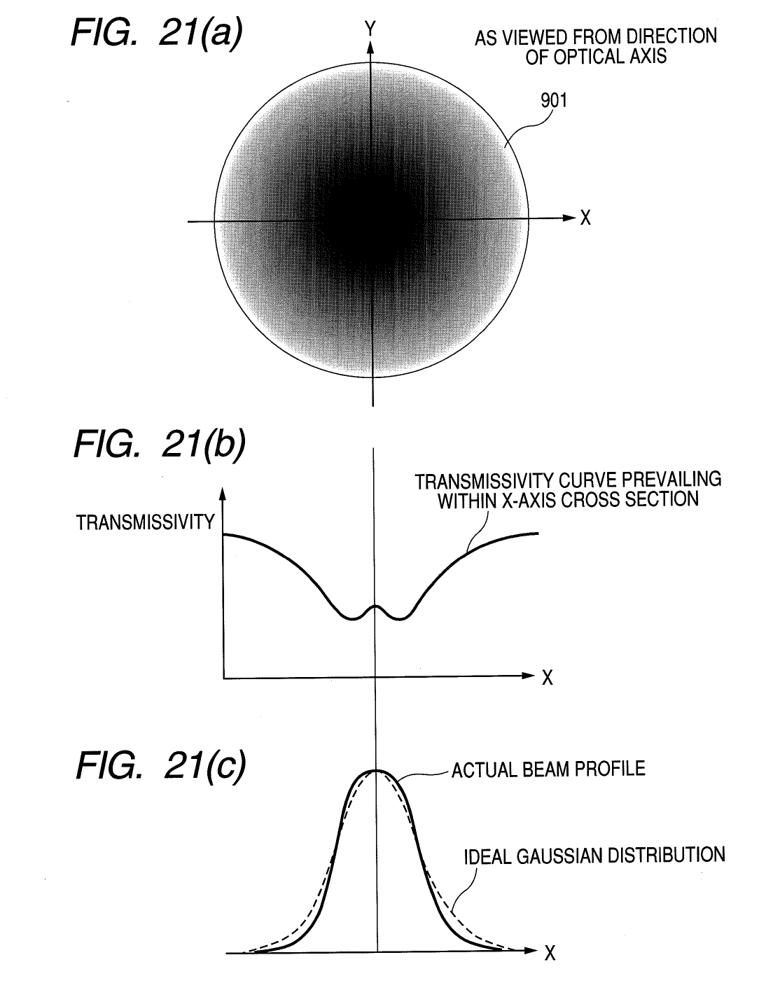

FIGS. 21A to 21C illustrate an embodiment of the profile correction element 901. As indicated in FIGS. 21A and 21B, this embodiment incorporates the function of a transmission filter having a predetermined density distribution. FIG. 21B shows a transmissivity curve prevailing within the X-axis cross section of the transmission filter. The deviation of an actual beam spot profile from the ideal Gaussian distribution is frequently caused when the profile of a light source beam, which is a source of the beam spot, does not agree with the ideal Gaussian distribution. Therefore, as indicated in FIG. 21C, the deviation of the actual light source beam profile from the ideal Gaussian distribution is determined beforehand, and the profile correction element 901 determines the density distribution in such a manner that the correct ideal Gaussian distribution is obtained after the beam travels through the profile correction element 901. For the sake of simplicity, FIG. 21B shows the transmissivity prevailing within the X-axis cross section. In reality, however, the density distribution is determined two-dimensionally while considering the profile in the Y-axis direction. When the profile correction element 901, which has determined the density distribution two-dimensionally, is placed in the optical path, the profile (illumination distribution) of the beam emitted from the profile correction element 901 is properly adjusted for the Gaussian distribution.

As described above, the third embodiment uses the profile correction element 901 to provide transmission type filtering. However, the present invention is not limited to the use of such a method. The present invention may use any other method as far as it provides profile corrections. Further, the profile correction element 901 may be placed at any appropriate position in accordance with the configuration of the irradiation optics. It need not always be placed in the position according to the third embodiment.

The profile correction element 901 need not always be used. Alternatively, it is possible to determine the profile (illumination distribution) directly from the beam spot image observed by the image processing section in the monitor 207, determine the deviation from the Gaussian distribution based on the results of the profile, and perform calculations to correct the foreign matter coordinates.

The third embodiment corrects a beam spot profile having a Gaussian distribution. However, the profile shape is not particularly defined. The present invention may also be used to correct a beam spot profile that has an illumination distribution other than the Gaussian distribution.

The spot diameter and profile corrections described above need not always be provided by a wafer surface inspection apparatus that uses the illumination system described in conjunction with the embodiments of the present invention. The wafer surface inspection apparatus may alternatively use a different illumination system. For example, the wafer surface inspection apparatus may use an illumination system that uses an acoustooptical element or galvanometer mirror to perform a periodic beam spot scan over the wafer.

The present invention determines the position coordinates of extremely small foreign matter and other defects on the wafer surface with high precision, accurately collates vertical irradiation results with oblique irradiation results, and accurately identifies the types (categories) of foreign matter and other defects while minimizing the detection sensitivity and foreign matter coordinate detection accuracy variations among apparatuses.

The present invention may be embodied in other specific forms without departing from the spirit or essential characteristics thereof. The embodiments described above are therefore to be considered in all respects as illustrative and not restrictive, the scope of the invention being indicated by the appended claims rather than by the foregoing description, and all changes which come within the meaning and range of equivalency of the claims are therefore intended to be embraced therein.

What is claimed is:

1. A wafer surface defect inspection apparatus comprising:
a stage for rotating a wafer;
an irradiation optics for forming a vertical irradiation beam spot by irradiating the surface of the wafer that is rotated by the stage, from a substantially vertical direction with a beam emitted from a first light source, changing the emitted beam, and forming an oblique irradiation beam spot by irradiating the surface of the wafer that is rotated by the stage for scanning purposes, from an oblique direction that is inclined from vertical;
a detection optics for collecting scattered light arising from foreign matter and other defects on the surface of the wafer, receiving the collected scattered light, and outputting a signal representing the received scattered light when the irradiation optics forms the beam spots on the surface of the wafer;
a height detection optics for shedding white light or broadband light, which is irradiated from a second light source, onto the vicinity of the oblique irradiation beam spot formed on the surface of the wafer by the irradiation optics, causing a detector to receive the resulting reflected light, and detecting the surface height of the wafer in the vicinity of the oblique irradiation beam spot; and
beam spot position correction means for correcting the position of the oblique irradiation beam spot that is formed on the wafer surface by the irradiation optics, in accordance with the information on the wafer's surface height prevailing in the vicinity of the oblique irradiation beam spot that is detected by the height detection optics.

2. The wafer surface defect inspection apparatus according to claim 1, wherein the detection optics includes a plurality of light reception optics for collecting scattered light arising from the foreign matter and other defects in each of a plurality of directions centered around the beam spots, receiving the collected scattered light, and outputting a signal representing the received scattered light.

3. The wafer surface defect inspection apparatus according to claim 1, wherein the beam spot position correction means includes an irradiation position correction optics that corrects the position of the oblique irradiation beam spot by deflecting the emitted beam that is shed onto the surface of the wafer from the oblique direction.

4. The wafer surface defect inspection apparatus according to claim 1, wherein the beam spot position correction means is configured to calculate a displacement correction value of the wafer surface in accordance with the wafer surface height information detected by the height detection optics and correct the position coordinates of the oblique irradiation beam spot by using the calculated displacement correction value.

5. The wafer surface defect inspection apparatus according to claim 3, wherein the beam spot position correction means makes corrections by exercising feedforward control in accordance with the height information prevailing one or more wafer revolutions earlier that is detected by the height detection optics.

6. The wafer surface defect inspection apparatus according to claim 3, wherein the beam spot position correction means makes corrections by exercising feedback control in accordance with real-time height information detected by the height detection optics.

7. The wafer surface defect inspection apparatus according to claim 1, further comprising:
beam spot detection means for detecting the positional displacement and dimensions of the vertical irradiation beam spot or oblique irradiation beam spot that is formed on the wafer surface by the irradiation optics;
an emitted beam correction optics for correcting the emission direction and emission position of a beam emitted from the first light source included in the irradiation optics; and
beam detection means for monitoring a beam position immediately after the emitted beam correction optics,
wherein the emitted beam correction optics corrects the emission direction and emission position of a beam emitted from the first light source in accordance with at least the positional displacement information on the vertical irradiation beam spot or oblique irradiation beam spot detected by the beam spot detection means and at least the positional displacement information on a beam that is emitted from the first light source and detected by the beam detection means.

8. The wafer surface defect inspection apparatus according to claim 7, wherein the irradiation optics includes a beam diameter enlargement optics that corrects the magnification of the emitted beam and emits the beam in accordance with at least the dimensional information on the vertical irradiation beam spot or oblique irradiation beam spot detected by the beam spot detection means.

9. The wafer surface defect inspection apparatus according to claim 7, wherein the beam spot detection means includes an observation optics for observing a beam spot image that is directly formed on the wafer surface or a surface equivalent to the wafer surface.

10. The wafer surface defect inspection apparatus according to claim 2, wherein the detection optics includes a low-angle light reception optics and a medium-angle light reception optics.

11. A wafer surface defect inspection apparatus comprising:
a stage for rotating a wafer;
an irradiation optics for forming an oblique irradiation beam spot by irradiating the surface of the wafer that is rotated by the stage, from an oblique direction inclined from vertical with a beam emitted from a first light source;
a detection optics for collecting scattered light arising from foreign matter and other defects on the surface of the wafer, receiving the collected scattered light, and outputting a signal representing the received scattered light when the irradiation optics forms the oblique irradiation beam spot on the surface of the wafer;
a height detection optics for shedding white light or broadband light, which is irradiated from a second light source, onto the vicinity of the oblique irradiation beam spot that is formed on the surface of the wafer by the irradiation optics, causing a detector to receive the resulting reflected light, and detecting the surface height of the wafer in the vicinity of the oblique irradiation beam spot; and
beam spot position correction means for correcting the position of the oblique irradiation beam spot that is formed on the wafer surface by the irradiation optics, in accordance with the information on the wafer's surface height prevailing in the vicinity of the oblique irradiation beam spot that is detected by the height detection optics.

12. A wafer surface defect inspection apparatus comprising:
a stage for rotating a wafer;
an irradiation optics for forming a vertical irradiation beam spot by irradiating the surface of the wafer that is rotated by the stage, from a substantially vertical direction with a beam emitted from a first light source, changing the emitted beam, and forming an oblique irradiation beam spot by irradiating the surface of the wafer that is rotated by the stage for scanning purposes, from an oblique direction that is inclined from vertical;
a detection optics for collecting scattered light arising from foreign matter and other defects on the surface of the wafer, receiving the collected scattered light, and outputting a signal representing the received scattered light when the irradiation optics forms the beam spots on the surface of the wafer;
beam spot detection means for detecting the positional displacement and dimensions of the vertical irradiation beam spot or oblique irradiation beam spot that is formed on the wafer surface by the irradiation optics;
an emitted beam correction optics for correcting the emission direction and emission position of a beam emitted from the first light source that is included in the irradiation optics; and
beam detection means for monitoring a beam position immediately after the emitted beam correction optics,
wherein the emitted beam correction optics corrects the emission direction and emission position of a beam emitted from the first light source in accordance with at least the positional displacement information on the vertical irradiation beam spot or oblique irradiation beam spot detected by the beam spot detection means and at least the positional displacement information on a beam that is emitted from the first light source and detected by the beam detection means.

13. The wafer surface defect inspection apparatus according to claim 12, wherein the irradiation optics further includes a spot diameter correction optics for making corrections to enlarge or reduce the diameter of a beam spot formed on the wafer surface in at least one direction, in accordance with at least the dimensional information on the vertical irradiation beam spot or oblique irradiation beam spot detected by the beam spot detection means.

14. The wafer surface defect inspection apparatus according to claim 13, wherein the spot diameter correction optics includes a beam diameter enlargement optics for adjusting a beam diameter magnification.

15. The wafer surface defect inspection apparatus according to claim 13, wherein the spot diameter correction optics includes a magnification adjustment/beam shaping optics for shaping a beam by adjusting the magnification.

16. The wafer surface defect inspection apparatus according to claim 1, wherein the irradiation optics further includes a profile correction element for correcting the illumination distribution of a beam spot formed on the wafer surface.

17. A wafer surface defect inspection method comprising:
a scanning step of rotating a wafer by driving a stage;
an irradiation step of forming a vertical irradiation beam spot by causing an irradiation optics to irradiate the surface of the wafer that is rotated in the scanning step, from a substantially vertical direction with a beam emitted from a first light source, change the emitted beam, and form an oblique irradiation beam spot by irradiating the surface of the wafer that is rotated in the scanning step for scanning purposes, from an oblique direction that is inclined from vertical;
a detection step of causing a detection optics to collect scattered light arising from foreign matter and other defects on the surface of the wafer, receive the collected scattered light, and output a signal representing the received scattered light when the beam spots is formed on the surface of the wafer in the irradiation step;
a height detection step of shedding white light or broadband light, which is irradiated from a second light source, onto the vicinity of the oblique irradiation beam spot that is formed on the surface of the wafer in the irradiation step, causing a detector to receive the resulting reflected light, and detecting the surface height of the wafer in the vicinity of the oblique irradiation beam spot; and
a beam spot position correction step of correcting the position of the oblique irradiation beam spot that is formed on the wafer surface in the irradiation step, in accordance with the information on the wafer's surface height prevailing in the vicinity of the oblique irradiation beam spot, which is detected in the height detection step.

18. The wafer surface defect inspection method according to claim 17, wherein the detection step includes the step of causing light reception optics to collect scattered light arising from the foreign matter and other defects in each of a plurality of directions centered around the beam spots, receive the collected scattered light, and output a signal representing the received scattered light.

19. The wafer surface defect inspection method according to claim 17, wherein the beam spot position correction step includes the step of correcting the position of the oblique irradiation beam spot by deflecting the emitted beam that is shed onto the surface of the wafer from the oblique direction.

20. The wafer surface defect inspection method according to claim 17, wherein the beam spot position correction step includes the step of calculating a displacement correction value of the wafer surface in accordance with the wafer surface height information detected in the height detection step and correcting the position coordinates of the oblique irradiation beam spot by using the calculated displacement correction value.

21. The wafer surface defect inspection method according to claim 17, further comprising:
a beam spot detection step of detecting the positional displacement and dimensions of the vertical irradiation beam spot or oblique irradiation beam spot that is formed on the wafer surface in the irradiation step;
an emitted beam correction step of correcting the emission direction and emission position of a beam emitted from the first light source in the irradiation step; and
a beam detection step of monitoring a beam position immediately after the emitted beam correction step,
wherein the emitted beam correction step includes the step of correcting the emission direction and emission position of a beam emitted from the first light source in accordance with at least the positional displacement information on the vertical irradiation beam spot or oblique irradiation beam spot detected in the beam spot detection step and at least the positional displacement information on a beam that is emitted from the first light source and detected in the beam detection step.

22. The wafer surface defect inspection method according to claim 21, wherein the irradiation step includes a spot diameter correction step of reducing or enlarging the diameter of the beam spot formed on the wafer surface in at least one direction for correction purposes in accordance with the information on at least the dimensions of the vertical irradiation beam spot or oblique irradiation beam spot detected in the beam spot detection step.

23. The wafer surface defect inspection method according to claim 22, wherein the spot diameter correction step includes a beam diameter enlargement step of adjusting a beam diameter magnification.

24. The wafer surface defect inspection method according to claim 22, wherein the spot diameter correction step includes a magnification adjustment/beam shaping step of shaping a beam by adjusting the magnification.

25. The wafer surface defect inspection method according to claim 17, wherein the irradiation step includes a profile correction step of correcting the illumination distribution of a beam spot formed on the wafer surface.
